(19) United States
(12) Patent Application Publication
(10) Pub. No.: US 2026/0267369 A1
(43) Pub. Date: Sep. 10, 2026

(54) METHODS AND APPARATUS FOR APPROXIMATING NUMERICAL COMPUTATIONS IN DEEP NEURAL NETWORKS

(71) Applicant: Intel Corporation, Santa Clara, CA (US)

(72) Inventors: Bogdan Pasca, Toulouse (FR); Hengyu Meng, Shanghai (CN); Zhe Wang, Shanghai (CN); Martin Langhammer, Alderbury, Salisbury (GB); Haihao Shen, Shanghai (CN)

(73) Assignee: Intel Corporation, Santa Clara, CA (US)

(21) Appl. No.: 19/469,236

(22) PCT Filed: May 25, 2023
(86) PCT No.: PCT/US2023/067493

§ 371 Date: Sep. 25, 2025

(30) Foreign Application Priority Data
Mar. 30, 2023 (WO) PCT/CN2023/085054

(51) Int. Cl. G06F 1/03; G06F 7/483

(52) U.S. Cl. CPC G06F 1/03; G06F 7/483

(57) ABSTRACT

Methods, apparatus, and systems are disclosed for approximating numerical computations in deep neural networks. An example apparatus includes at least one memory, machine readable instructions, and programmable circuitry to at least one of instantiate or execute the machine readable instructions to generate a lookup table based on input elements, index the lookup table using tensor values, the tensor values associated with an output index, and output a vector in destination numeric format based on the lookup table, the vector including output values in a floating-point representation.

### RELATED APPLICATIONS

This patent claims the benefit of PCT Application No. PCT/CN2023/085054, filed Mar. 30, 2023, entitled “Methods and Apparatus for Approximating Numerical Computations in Deep Neural Networks.” The entire disclosure of PCT Application No. PCT/CN2023/085054 is hereby incorporated by reference in its entirety.

### FIELD OF THE DISCLOSURE

This disclosure relates generally to software processing, and, more particularly, to methods, systems, and apparatus for approximating numerical computations in deep neural networks.

### BACKGROUND

Deep neural networks (DNN) such as convolutional neural networks (CNNs) and recurrent neural networks (RNNs) can be used to provide accurate solutions for problems associated with a variety of fields, including image classification, speech recognition, medical diagnosis, and/or autonomous driving. An increase in the size of datasets and a corresponding increase in DNN complexity results in increases in the computational intensity and memory demands of deep learning-based tasks.

### BRIEF DESCRIPTION OF THE DRAWINGS

FIG. 1 is an example environment in which numerical computation is performed using example numerical computation approximator circuitry in accordance with teachings disclosed herein.

FIG. 2 is a block diagram representative of the numerical computation approximator circuitry that may be implemented in the example environment of FIG. 1.

FIG. 3 is a flowchart representative of machine-readable instructions which may be executed to implement the example numerical computation approximator circuitry of FIG. 1 to perform numerical approximation in accordance with teachings disclosed herein.

FIG. 4 is a flowchart representative of machine-readable instructions which may be executed to implement the example numerical computation approximator circuitry of FIG. 1 to generate an element array (e.g., lookup table) tabulating function output.

FIG. 5 is a flowchart representative of machine-readable instructions which may be executed to implement the example numerical computation approximator circuitry of FIG. 1 to perform softmax-based lookup table (LUT) generation.

FIG. 6 is a flowchart representative of machine-readable instructions which may be executed to implement the example numerical computation approximator circuitry of FIG. 1 to perform softmax-based lookup table generation for wide vectors.

FIG. 7 is an example of element array (lookup table) generation using the numerical computation approximator circuitry of FIG. 1 in accordance with the machine-readable instructions of FIGS. 3 and/or 4.

FIG. 8 is an example of softmax based lookup table generation using the numerical computation approximator circuitry of FIG. 1 in accordance with the machine-readable instructions of FIGS. 3 and/or 5.

FIGS. 9A-9B show an example of softmax based lookup table generation for wide vectors using the numerical computation approximator circuitry of FIG. 1 in accordance with the machine-readable instructions of FIGS. 3 and/or 6.

FIG. 10 shows example results for two matrix sizes that illustrate the reduction of system performance using non-linear function calls.

FIG. 11 illustrates example tabulation and compute identifiers alongside an average relative error and an example polynomial argument creation based on quantized input bits for the implementation associated with the tabulation and compute identifiers shown.

FIG. 12 illustrates example results associated with piecewise-polynomial and range-reduction for degree-d approximation based on quantized input data in accordance with teachings disclosed herein.

FIGS. 13A-13F illustrate example graphical representations of the relative error associated with the tabulated results of FIGS. 11-12.

FIGS. 14A-14B includes example performance data associated with pure-eltwiseop exp, eltwiseop-intensive non-computation-bound op softmax, and a GELU activation function.

FIG. 15 is a block diagram of an example processing platform structured to execute the instructions of FIGS. 3-6 to implement the example numerical computation approximator circuitry of FIG. 1 to perform numerical approximation in accordance with teachings disclosed herein.

FIG. 16 is a block diagram of an example implementation of the processor circuitry of FIG. 15.

FIG. 17 is a block diagram of another example implementation of the processor circuitry of FIG. 15.

FIG. 18 is a block diagram of an example software distribution platform (e.g., one or more servers) to distribute software (e.g., software corresponding to the example machine readable instructions of FIG. 3) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not to scale. Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly that might, for example, otherwise share a same name.

As used herein, the phrase “in communication,” including variations thereof, encompasses direct communication and/or indirect communication through one or more intermediary components, and does not need direct physical (e.g., wired) communication and/or constant communication, but rather additionally includes selective communication at periodic intervals, scheduled intervals, aperiodic intervals, and/or one-time events.

As used herein, “processor circuitry” is defined to include (i) one or more special purpose electrical circuits structured to perform specific operation(s) and including one or more semiconductor-based logic devices (e.g., electrical hardware implemented by one or more transistors), and/or (ii) one or more general purpose semiconductor-based electrical circuits programmable with instructions to perform specific operations and including one or more semiconductor-based logic devices (e.g., electrical hardware implemented by one or more transistors). Examples of processor circuitry include programmable microprocessors, Field Programmable Gate Arrays (FPGAs) that may instantiate instructions, Central Processor Units (CPUs), Graphics Processor Units (GPUs), Digital Signal Processors (DSPs), XPUs, or microcontrollers and integrated circuits such as Application Specific Integrated Circuits (ASICs). For example, an XPU may be implemented by a heterogeneous computing system including multiple types of processor circuitry (e.g., one or more FPGAs, one or more CPUs, one or more GPUs, one or more DSPs, etc., and/or a combination thereof) and application programming interface(s) (API(s)) that may assign computing task(s) to whichever one(s) of the multiple types of processor circuitry is/are best suited to execute the computing task(s).

### DETAILED DESCRIPTION

Deep neural networks (DNNs) have allowed for state-of-the-art accuracy to be achievable for a wide range of tasks. However, the adoption of DNNs in some fields has been hindered by lengthy and complex training processes, combined with the high compute cost of the inference phase associated with deep learning. For example, while the training phase represents the process used by a machine to learn and optimize models from data, the inference phase represents the use of trained models to predict and/or estimate outcomes from new observations in efficient deployments. The inference phase of deep learning allows machines to bridge gaps between data used for training and ambiguous information in the real world (e.g., through extrapolation of features that the DNN recognizes). Most DNN models include two types of operators: (1) computation-intensive operators involving matrix-matrix multiplications (e.g., GEMM) and convolutions (CONV), and (2) non-computation-bound operators including element-wise operators (e.g., GELU, ReLU, etc.), element-reduce operators, etc. Although these non-computation-bound operators have a much lower cost compared to CONV/GEMM kernels, the efficiency of these operators in terms of compute cycles and in terms of accuracy is essential for efficient deployment of DNN models in hardware constrained scenarios.

In some examples, approximating numerical computations using table lookup is of particular interest for scenarios where a relatively small number of input bits affect the result of an otherwise complex calculation. In such cases, the entire computational data path may be replaced with a single lookup table, the computational data path being driven by a small number of input bits which may consist of several costly operators (e.g., elementary, or transcendental functions). For example, the computational data path can be replaced with a single lookup table when low-precision tensor values (e.g., int8/bfloat8, a 4-bit representation data type, etc.) input certain non-linear computations (e.g., activation functions, softmax kernels, etc.). In some examples, non-computation operators can present a key bottleneck of model performance due to difficulties in fusing these operators. While some architectures can maintain support for certain element-wise computation capabilities (e.g., needed for implementing element-wise non-linear functions), supporting higher-density low-precision (e.g., int8, bf16, fp16, bf8) tensor/vector-product compute capabilities is desirable, given that significant compute acceleration concerning the compute-intensive parts of DNNs (e.g., including CONV and GEMM) is expected. Existing matrix acceleration technologies (e.g., AMX or “Tensor Core”) usually introduce different registers from vector units (e.g., AVX512, CUDA core, etc.). Fusing non-computation bound operators into previous CONV/GEMM layers can benefit from transferring data between matrix and vector/core register stacks and/or adding additional input/output pressure.

Methods and apparatus disclosed herein facilitate use of customizable bit-width lookup-based implementations in element-wise operator (e.g., eltwiseop)-intensive operators. Compared to the state-of-the-art, the proposed techniques increase the range of the lookup table which results in higher accuracy and provides more powerful representation capabilities. In examples disclosed herein, the customizable bit-width lookup-table based implementation can be used to output values directly in a floating-point representation, such as FP16 (e.g., half-precision) or bfloat16. In examples disclosed herein, several lookup-based implementations can be mixed with standard arithmetic computations for non-linear operator implementations in DNN models. Furthermore, in examples disclosed herein, a novel softmax implementation specifically geared towards wide vectors that significantly reduces the number of exponential calls is introduced, thus significantly reducing the total compute time. Additionally, in examples disclosed herein, novel polynomial-based implementations (i) input data in the tensor format and output data in floating-point and (ii) provide tradeoffs between lookup cost (e.g., in number of bits), compute (e.g., using multiply-add calls), and accuracy. In some examples, lookup reduction between 93% and 75% is achieved compared to a lookup-only based solution, at the expense of at most three multiply-add calls. In examples disclosed herein, an exponential-function specific implementation is introduced that (i) inputs data in tensor format, (ii) proposes a de-quantized range-reduction capability, and (iii) provides a tradeoff between tabulated lookup table (LUT) cost, compute cost and parallelization.

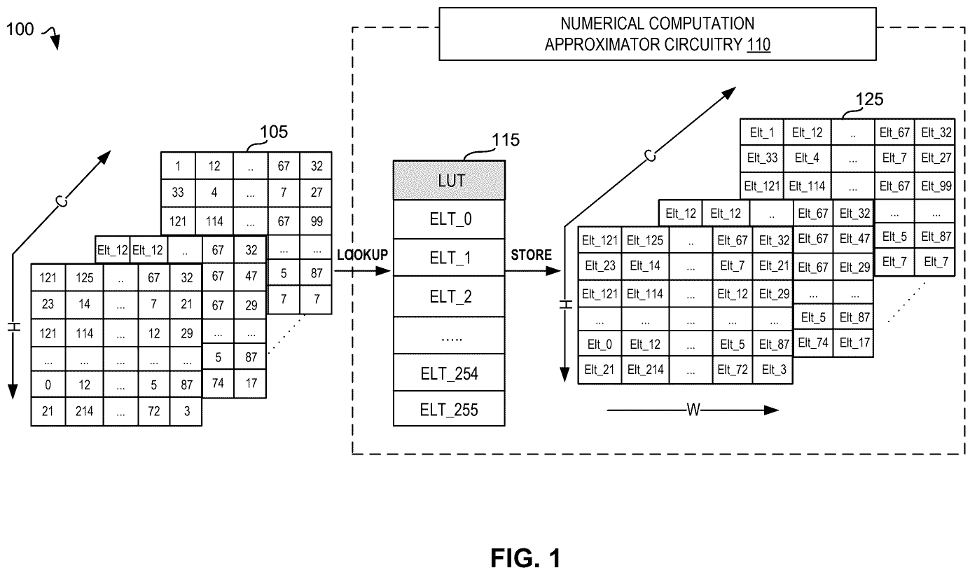

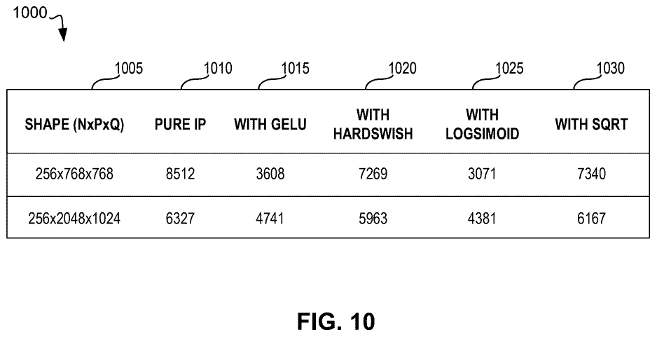

FIG. 1 is an example environment 100 in which container verification is performed using example container verification circuitry 110 in accordance with teachings disclosed herein. In some examples, a lookup-based implementation uses the input tensor value as a table index. For example, if an input type is unsigned int8, an array is constructed with 256 elements, indexed by values in the range {0, . . . , 255} (e.g., where the input tensor value i corresponds to a dequantized value j). The array entry for index i will correspond to the function output as evaluated in point j. FIG. 1 shows in detail an example where the same lookup-table based implementation is called for all elements of a C×H×W structure. In the example of FIG. 1, an input 105 having a C×H structure is provided to numerical computation approximator circuitry 110, which generates a lookup table (LUT) 115, providing an output 125 with a C×H×W structure. Using some known systems (e.g., AMX), the tensors can be stored in cache from a first type of register (e.g., TMM register) to then be loaded again to a second type of register (e.g., ZMM register), and the bottleneck of cache can greatly lower the fusion benefit. The same happens in the case of the GPU where, for example, tensor cores in GPUs use different registers from Compute Unified Device Architecture (CUDA) cores, so the fusion benefit is greatly impacted by shared graphic memory bandwidth. As shown in the example of FIG. 10, table 1000 presents the performance (e.g., reported in giga floating-point operations per second (GFLOPS)) measured on an SPR kernel (e.g., performing a rank-1 update of a symmetric packed matrix) using different non-linear functions for each output element. The table 1000 reports numbers for two matrix sizes (N,P,Q) with A(N,P) and B(P,Q), where Size [0]=(256, 768, 768) and Size [1]=(256, 2048, 1024). The results show just how much these non-linear function calls reduce the performance of the system. It is therefore imperative to find efficient ways to implement these activation functions. Methods and apparatus disclosed herein improve the efficiency of activation function implementations for numerical approximations in deep neural networks.

In some known systems, DNN libraries (e.g., oneDNN) eltwiseop-intensive operations can accept low precision (e.g., int8) tensors as input directly but internally convert to a wider bit-width representation (e.g., softmax) or insert dequantization nodes before the eltwiseop-intensive operations. Likewise, lookup-based approaches are widely explored, but few are deployed. TensorFlow optimization tools introduces an 8-bit LUT focus on pure-eltwiseop-chain operations which take int8 as input and output, but stalls as an experimental API. For example, oneDNN usually converts low-precision input to more high-precision data types which prevents gaining of the low-precision benefit and introduces additional cost for data type conversion. Using such an approach prevents full utilization of hardware low precision arithmetic capabilities. Since future hardware will bring higher computation capability for low precision, acceleration capabilities can be improved. For example, traditional LUTs focus on fully int8 inference/training and pure-eltwiseop but are not able to cover bf16/bf8 with even more low-precision floating representation, which may be needed for subsequent operator(s).

In examples disclosed herein, softmax function-based LUTs are implemented. For example, during the inference phase of deep learning, the final network layer may contain a call to the softmax function. The softmax function is used to calculate the probability (e.g., a value between 0 and 1) that the network input is classified in the bin associated with a particular network output. The mathematical definition of the softmax function is shown in connection with Equation 1 below:

$${σ ( \vec{z} )}_{i} = \frac{{e}^{{z}_{i}}}{{\sum }_{j = 1}^{K} {e}^{{z}_{j}}} \qquad Equation 1$$

In the example of Equation 1, each element of the output vector \vec{σ}depends on all the elements of the input vector \vec{z}. Equation 1 shows that a common denominator (e.g., the sum of exponentials over the input elements of the input vector z) is used to scale each output vector value. Each element of the output vector is computed as the ratio between the exponential value of element zᵢ, and the common sum-of-exponentials scale factor. As such, the computation of the softmax function can become a bottleneck due to all the exponential function calls. During the training phase of deep learning, some activation functions, and their derivatives (e.g., used for a stochastic gradient descent training method) are also used. The GELU activation function is one such example, as shown in connection with Equation 2:

$$GELU ( x ) = \frac{1}{2} x ( 1 + erf ( \frac{x}{\sqrt{2}} ) ) \qquad Equation 2$$

In some examples, non-computation-bound operators are pure element-wise operators (e.g., eltwiseop) that apply to all elements of a tensor or contain eltwiseop-intensive sub-operators which are used in the inference and training phases. Accelerating the computation of these operators in the context of low-precision inference is very important in model acceleration and compression. Methods and apparatus disclosed herein accelerate the eltwiseop-intensive non-computation-bound DNN operators while providing an accuracy that is sufficient for these models. With increasing compute capabilities that are set to reduce the time spent in computationally-bound portions of the code, reducing the time needed by the odd element-wise arithmetic operators would greatly improve methods of numerical computation for deep neural networks.

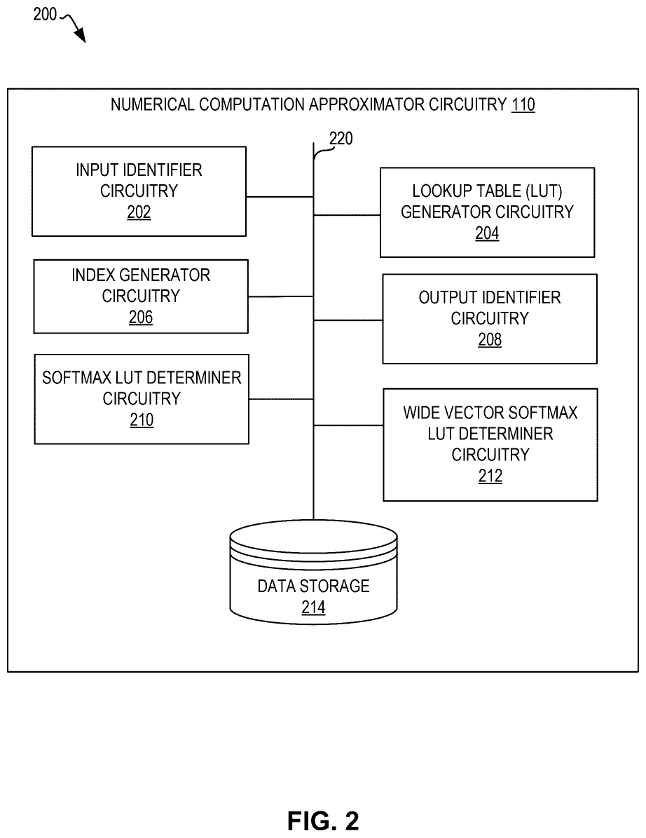

FIG. 2 is a block diagram 200 of an example implementation of container verification circuitry 110 of FIG. 2. The container verification circuitry 110 of FIG. 2 may be instantiated (e.g., creating an instance of, bring into being for any length of time, materialize, implement, etc.) by processor circuitry such as a central processing unit executing instructions. Additionally or alternatively, the container verification circuitry 110 of FIG. 2 may be instantiated (e.g., creating an instance of, bring into being for any length of time, materialize, implement, etc.) by an ASIC or an FPGA structured to perform operations corresponding to the instructions. It should be understood that some or all of the circuitry of FIG. 2 may, thus, be instantiated at the same or different times. Some or all of the circuitry may be instantiated, for example, in one or more threads executing concurrently on hardware and/or in series on hardware. Moreover, in some examples, some or all of the circuitry of FIG. 2 may be implemented by microprocessor circuitry executing instructions to implement one or more virtual machines and/or containers.

In the example of FIG. 2, the numerical computation approximator circuitry 110 includes example input identifier circuitry 202, example lookup table (LUT) generator circuitry 204, example index generator circuitry 206, example output identifier circuitry 208, example softmax LUT determiner circuitry 210, example wide vector softmax LUT determiner circuitry 212, and example data storage 214. In the example of FIG. 2, the input identifier circuitry 202, the lookup table (LUT) generator circuitry 204, the index generator circuitry 206, the output identifier circuitry 208, the softmax LUT determiner circuitry 210, the wide vector softmax LUT determiner circuitry 212, and/or the data storage 214 are in communication via an example bus 220.

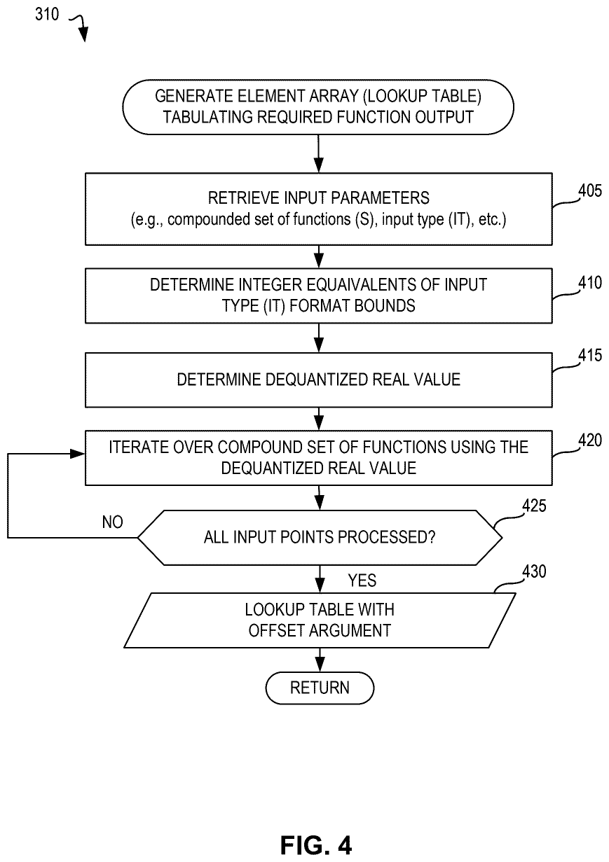

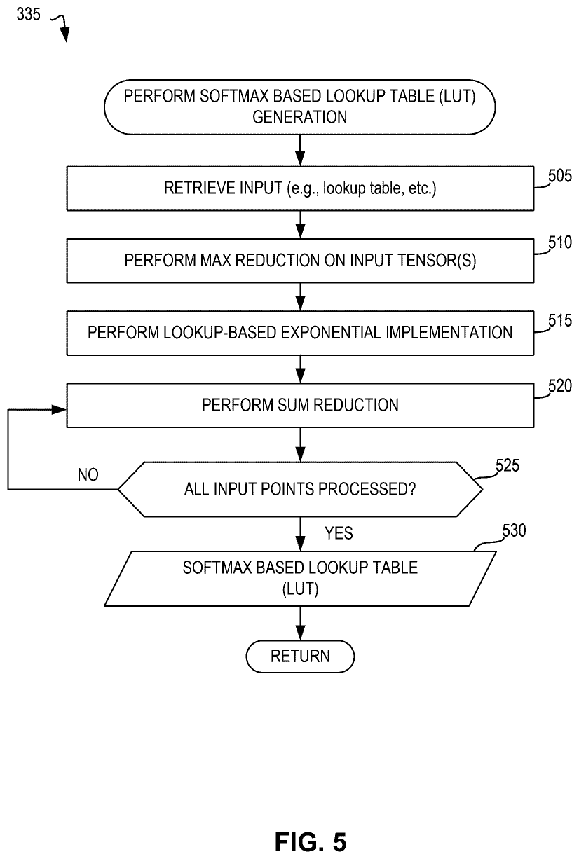

The input identifier circuitry 202 determines inputs such as a compounded set of functions for generation(S), an input type (IT), quantization scheme parameters (Q), and/or an output data type (OT). In some examples, the input identifier circuitry 202 identifies a lookup table (LUT) as input and/or a source vector (src-vec). For example, as described in more detail in connection with FIGS. 4, 5, and/or 6, the input identifier circuitry 202 retrieves input parameter(s) for use in generating an element array (e.g., LUT) tabulating function output, for performing softmax based LUT generation, and/or for performing softmax based LUT generation for wide vectors.

The lookup table (LUT) generator circuitry 204 generates a lookup table. For example, the LUT generator circuitry 204 generates a lookup table based on a compounded set of functions for generation(S), an input type (IT), quantization scheme parameters (Q), and/or an output data type (OT). For example, the LUT generator circuitry 204 performs variable set-up, and identifies a LUT index. In some examples, the LUT generator circuitry 204 outputs the lookup table for the compound set of functions(S) and an optional offset argument, as described in more detail in connection with FIGS. 4 and/or 7.

The index generator circuitry 206 performs indexing of the lookup table generated using the LUT generator circuitry 204. In some examples, index generator circuitry 206 indexes the lookup table(s) using tensor values, as described in more detail in connection with FIGS. 4 and/or 7. For example, a tensor value in a source vector can be associated with a specific output index. In some examples, the index generator circuitry 206 determines a subinterval index from a quantized input by analyzing a given number of bits, as described in connection with FIG. 10A.

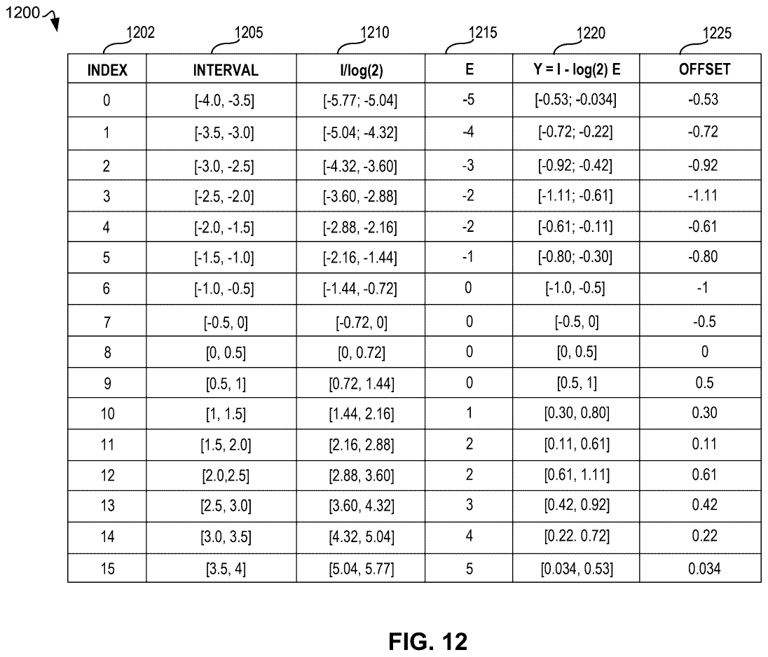

The output identifier circuitry 208 determines output to generate based on the provided input(s). For example, the output identifier circuitry 208 generates the lookup table (T) as output for the compound set of functions(S). In some examples, the output identifier circuitry 208 generates an optional offset argument (O), as described in more detail in connection with FIGS. 4 and/or 7. In some examples, the output identifier circuitry 208 generates a destination vector based on exponential values, as described in more detail in connection with FIG. 12.

The softmax LUT determiner circuitry 210 generates a mixture LUT algorithm, as described in connection with FIG. 4. For example, the softmax LUT determiner circuitry 210 splits the operator into two parts, such that certain operations (e.g., “exp”, “log” calculations) can be performed based on the LUT for all inputs, and other “multiply” and “division” operations can be performed in the numerical methods. In some examples, the softmax LUT determiner circuitry 210 determines integer equivalents of input type format bounds, identifies dequantized real value(s), and iterated over a compound set of functions using the dequantized value(s) to generate the lookup table, as described in more detail in connection with FIG. 4.

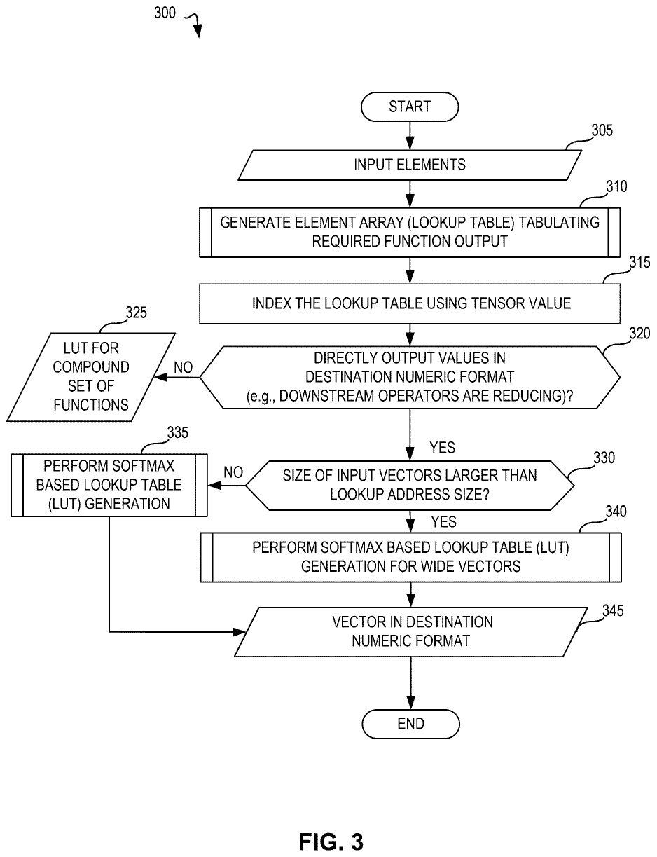

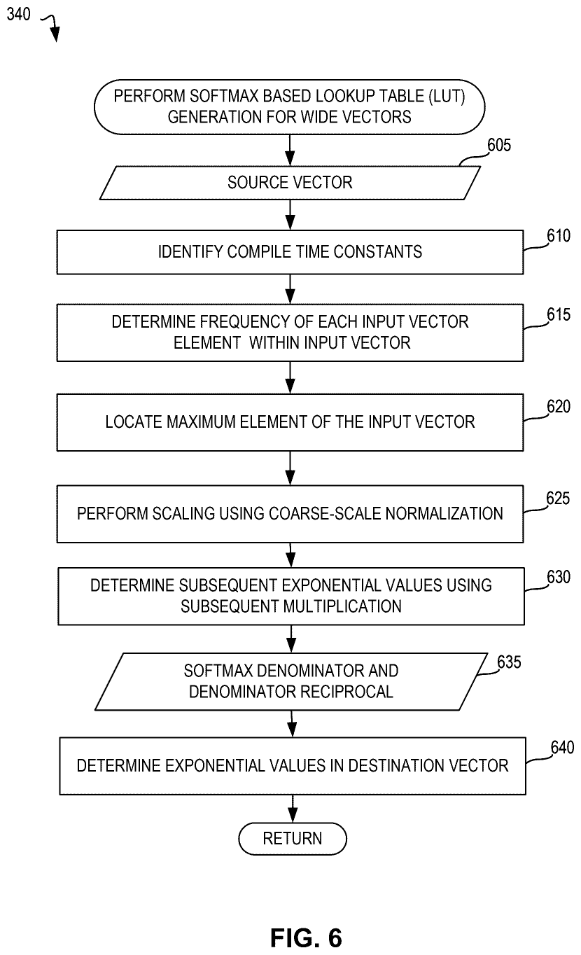

The wide vector softmax LUT determiner circuitry 212 performs softmax-based operations to generate a lookup table for wide vectors. For example, the wide vector softmax LUT determiner circuitry 212 can be used to directly output values in a destination numeric format, such as when downstream operators are reducing, as described in connection with FIGS. 3, 6, 9A and 9B. In some examples, the wide vector softmax LUT determiner circuitry 212 determines whether the size of an input vector is larger than a lookup address size. In some examples, the wide vector softmax LUT determiner circuitry 212 generates an output that consists of a vector in destination numeric format. For example, the wide vector softmax LUT determiner circuitry 212 can determine exponential values in a destination vector format based on identified softmax denominator(s) and/or denominator reciprocal(s), as described in connection with FIG. 6.

The data storage 214 can be used to store any information associated with the input identifier circuitry 202, the lookup table (LIT) generator circuitry 204, the index generator circuitry 206, the output identifier circuitry 208, the softmax LUT determiner circuitry 210, and/or the wide vector softmax LUT determiner circuitry 212. The example data storage 214 of the illustrated example of FIG. 2 can be implemented by any memory, storage device and/or storage disc for storing data such as flash memory, magnetic media, optical media, etc. Furthermore, the data stored in the example data storage 214 can be in any data format such as binary data, comma delimited data, tab delimited data, structured query language (SQL) structures, image data, etc.

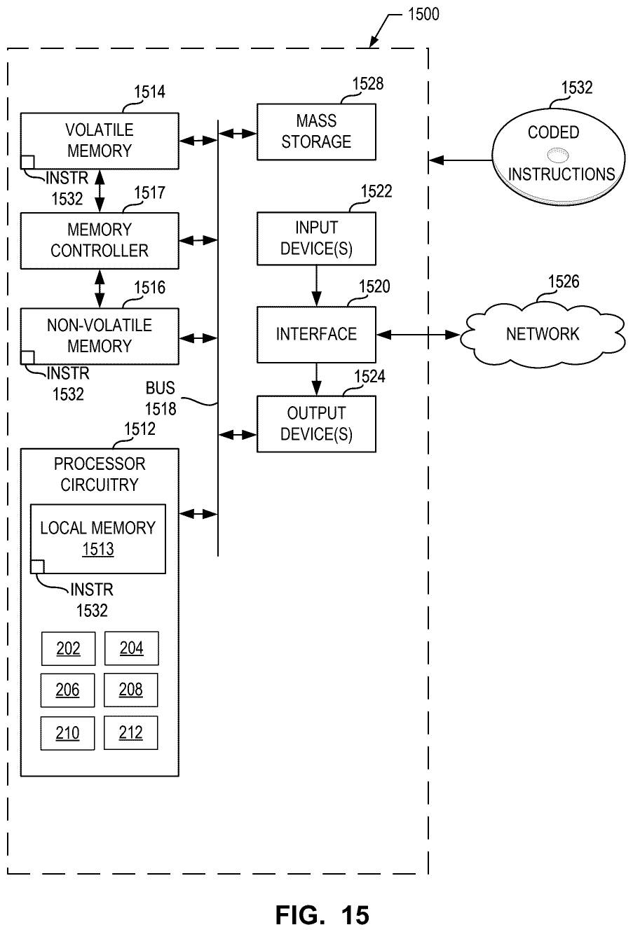

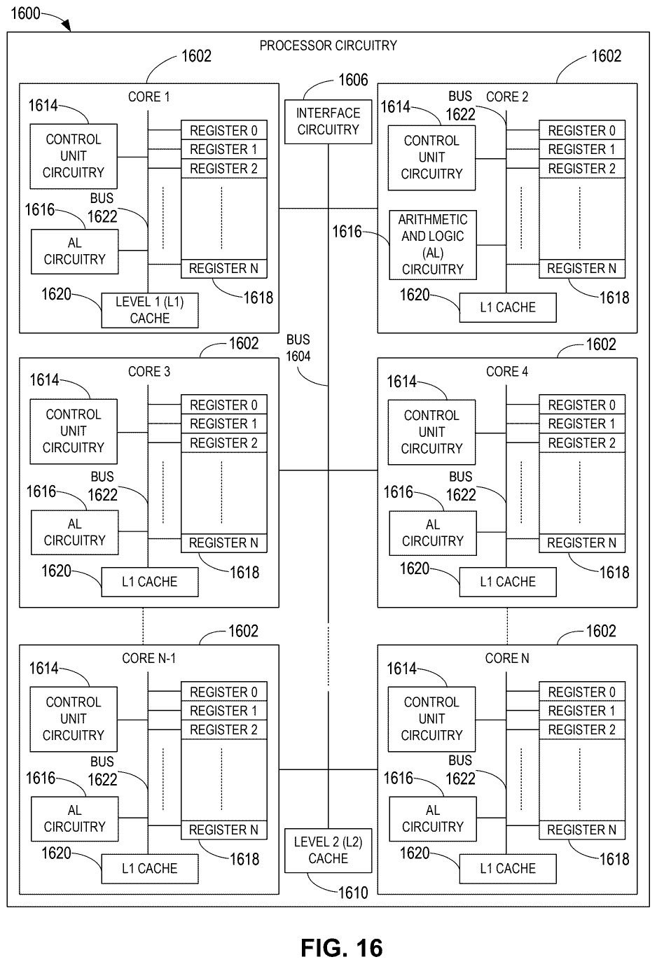

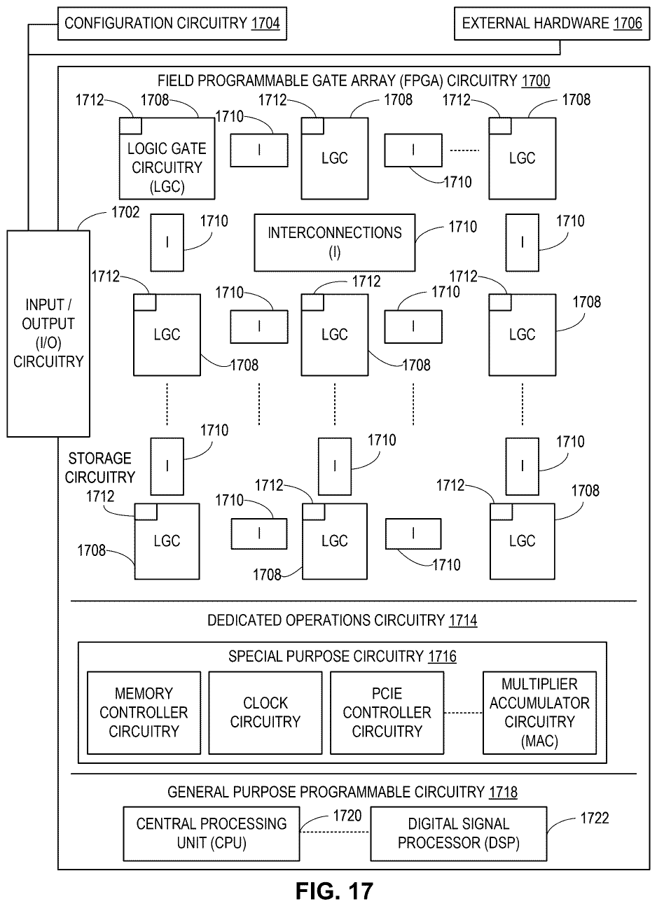

In some examples, the apparatus includes means for identifying input. For example, the means for identifying input may be implemented by input identifier circuitry 202. In some examples, the input identifier circuitry 202 may be instantiated by processor circuitry such as the example processor circuitry 1512 of FIG. 15. For instance, the input identifier circuitry 202 may be instantiated by the example microprocessor 1600 of FIG. 16 executing machine executable instructions such as those implemented by at least block 305 of FIG. 3. In some examples, the input identifier circuitry 202 may be instantiated by hardware logic circuitry, which may be implemented by an ASIC, XPU, or the FPGA circuitry 1700 of FIG. 17 structured to perform operations corresponding to the machine readable instructions. Additionally or alternatively, the input identifier circuitry 202 may be instantiated by any other combination of hardware, software, and/or firmware. For example, the input identifier circuitry 202 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the apparatus includes means for generating a lookup table (LUT). For example, the means for generating a lookup table may be implemented by lookup table (LUT) generator circuitry 204. In some examples, the lookup table (LUT) generator circuitry 204 may be instantiated by processor circuitry such as the example processor circuitry 1512 of FIG. 15. For instance, the lookup table (LUT) generator circuitry 204 may be instantiated by the example microprocessor 1600 of FIG. 16 executing machine executable instructions such as those implemented by at least block 310 of FIG. 3. In some examples, the lookup table (LUT) generator circuitry 204 may be instantiated by hardware logic circuitry, which may be implemented by an ASIC, XPU, or the FPGA circuitry 1700 of FIG. 17 structured to perform operations corresponding to the machine readable instructions. Additionally or alternatively, the lookup table (LUT) generator circuitry 204 may be instantiated by any other combination of hardware, software, and/or firmware. For example, the lookup table (LUT) generator circuitry 204 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the apparatus includes means for generating an index. For example, the means for generating an index may be implemented by index generator circuitry 206. In some examples, the index generator circuitry 206 may be instantiated by processor circuitry such as the example processor circuitry 1512 of FIG. 15. For instance, the index generator circuitry 206 may be instantiated by the example microprocessor 1600 of FIG. 16 executing machine executable instructions such as those implemented by at least block 315 of FIG. 3. In some examples, the index generator circuitry 206 may be instantiated by hardware logic circuitry, which may be implemented by an ASIC, XPU, or the FPGA circuitry 1700 of FIG. 17 structured to perform operations corresponding to the machine readable instructions. Additionally or alternatively, the index generator circuitry 206 may be instantiated by any other combination of hardware, software, and/or firmware. For example, the index generator circuitry 206 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the apparatus includes means for identifying an output. For example, the means for identifying an output may be implemented by output identifier circuitry 208. In some examples, the output identifier circuitry 208 may be instantiated by processor circuitry such as the example processor circuitry 1512 of FIG. 15. For instance, the output identifier circuitry 208 may be instantiated by the example microprocessor 1600 of FIG. 16 executing machine executable instructions such as those implemented by at least block 320 of FIG. 3. In some examples, the output identifier circuitry 208 may be instantiated by hardware logic circuitry, which may be implemented by an ASIC, XPU, or the FPGA circuitry 1700 of FIG. 17 structured to perform operations corresponding to the machine readable instructions. Additionally or alternatively, the output identifier circuitry 208 may be instantiated by any other combination of hardware, software, and/or firmware. For example, the output identifier circuitry 208 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the apparatus includes means for determining a softmax (LUT). For example, the means for determining a softmax LUT may be implemented by softmax LUT determiner circuitry 210. In some examples, the softmax LUT determiner circuitry 210 may be instantiated by processor circuitry such as the example processor circuitry 1512 of FIG. 15. For instance, the softmax LUT determiner circuitry 210 may be instantiated by the example microprocessor 1600 of FIG. 16 executing machine executable instructions such as those implemented by at least block 335 of FIG. 3. In some examples, the softmax LUT determiner circuitry 210 may be instantiated by hardware logic circuitry, which may be implemented by an ASIC, XPU, or the FPGA circuitry 1700 of FIG. 17 structured to perform operations corresponding to the machine readable instructions. Additionally or alternatively, the softmax LUT determiner circuitry 210 may be instantiated by any other combination of hardware, software, and/or firmware. For example, the softmax LUT determiner circuitry 210 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

In some examples, the apparatus includes means for determining a wide vector softmax LUT. For example, the means for determining a wide vector softmax LUT may be implemented by wide vector softmax LUT determiner circuitry 212. In some examples, the wide vector softmax LUT determiner circuitry 212 may be instantiated by processor circuitry such as the example processor circuitry 1512 of FIG. 15. For instance, the wide vector softmax LUT determiner circuitry 212 may be instantiated by the example microprocessor 1600 of FIG. 16 executing machine executable instructions such as those implemented by at least block 340 of FIG. 3. In some examples, the wide vector softmax LUT determiner circuitry 212 may be instantiated by hardware logic circuitry, which may be implemented by an ASIC, XPU, or the FPGA circuitry 1700 of FIG. 17 structured to perform operations corresponding to the machine readable instructions. Additionally or alternatively, the wide vector softmax LUT determiner circuitry 212 may be instantiated by any other combination of hardware, software, and/or firmware. For example, the wide vector softmax LUT determiner circuitry 212 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) structured to execute some or all of the machine readable instructions and/or to perform some or all of the operations corresponding to the machine readable instructions without executing software or firmware, but other structures are likewise appropriate.

While an example manner of implementing the numerical computation approximator circuitry 110 of FIG. 1 is illustrated in FIG. 2, one or more of the elements, processes and/or devices illustrated in FIG. 2 may be combined, divided, re-arranged, omitted, eliminated and/or implemented in any other way. Further, the example input identifier circuitry 202, example lookup table (LIT) generator circuitry 204, example index generator circuitry 206, example output identifier circuitry 208, example softmax LUT determiner circuitry 210, example wide vector softmax LUT determiner circuitry 212, and/or, more generally, the example numerical computation approximator circuitry 110 of FIG. 1 may be implemented by hardware, software, firmware and/or any combination of hardware, software and/or firmware. Thus, for example, any of example input identifier circuitry 202, example lookup table (LIT) generator circuitry 204, example index generator circuitry 206, example output identifier circuitry 208, example softmax LUT determiner circuitry 210, example wide vector softmax LUT determiner circuitry 212, and/or, more generally, the example numerical computation approximator circuitry 110 of FIG. 1 could be implemented by processor circuitry, analog circuit(s), digital circuit(s), logic circuit(s), programmable processor(s), programmable microcontroller(s), graphics processing unit(s) (GPU(s)), digital signal processor(s) (DSP(s)), application specific integrated circuit(s) (ASIC(s)), programmable logic device(s) (PLD(s)), and/or field programmable logic device(s) (FPLD(s)) such as Field Programmable Gate Arrays (FPGAs). Further still, the example numerical computation approximator circuitry 110 of FIG. 1 may include one or more elements, processes, and/or devices in addition to, or instead of, those illustrated in FIG. 2, and/or may include more than one of any or all of the illustrated elements, processes and devices.

Flowchart representative of example machine readable instructions, which may be executed to configure processor circuitry to implement the numerical computation approximator circuitry 110 of FIG. 1 are shown in FIGS. 3-6. The machine readable instructions may be one or more executable programs or portion(s) of an executable program for execution by processor circuitry, such as the processor circuitry 1512 shown in the example processor platform 1500 discussed below in connection with FIG. 15 and/or the example processor circuitry discussed below in connection with FIGS. 16 and/or 17. The program may be embodied in software stored on one or more non-transitory computer readable storage media such as a compact disk (CD), a floppy disk, a hard disk drive (HDD), a solid-state drive (SSD), a digital versatile disk (DVD), a Blu-ray disk, a volatile memory (e.g., Random Access Memory (RAM) of any type, etc.), or a non-volatile memory (e.g., electrically erasable programmable read-only memory (EEPROM), FLASH memory, an HDD, an SSD, etc.) associated with processor circuitry located in one or more hardware devices, but the entire program and/or parts thereof could alternatively be executed by one or more hardware devices other than the processor circuitry and/or embodied in firmware or dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a user) or an intermediate client hardware device (e.g., a radio access network (RAN)) gateway that may facilitate communication between a server and an endpoint client hardware device). Similarly, the non-transitory computer readable storage media may include one or more mediums located in one or more hardware devices. Further, although the example program is described with reference to the flowcharts illustrated in FIGS. 3-6, many other methods of implementing the example numerical computation approximator circuitry 110 of FIG. 1 may alternatively be used. For example, the order of execution of the blocks may be changed, and/or some of the blocks described may be changed, eliminated, or combined. Additionally or alternatively, any or all of the blocks may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The processor circuitry may be distributed in different network locations and/or local to one or more hardware devices (e.g., a single-core processor (e.g., a single core central processor unit (CPU)), a multi-core processor (e.g., a multi-core CPU, an XPU, etc.) in a single machine, multiple processors distributed across multiple servers of a server rack, multiple processors distributed across one or more server racks, a CPU and/or a FPGA located in the same package (e.g., the same integrated circuit (IC) package or in two or more separate housings, etc.).

The machine readable instructions described herein may be stored in one or more of a compressed format, an encrypted format, a fragmented format, a compiled format, an executable format, a packaged format, etc. Machine readable instructions as described herein may be stored as data or a data structure (e.g., as portions of instructions, code, representations of code, etc.) that may be utilized to create, manufacture, and/or produce machine executable instructions. For example, the machine readable instructions may be fragmented and stored on one or more storage devices and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of machine executable instructions that implement one or more operations that may together form a program such as that described herein.

In another example, the machine readable instructions may be stored in a state in which they may be read by processor circuitry, but require addition of a library (e.g., a dynamic link library (DLL)), a software development kit (SDK), an application programming interface (API), etc., in order to execute the machine readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable media, as used herein, may include machine readable instructions and/or program(s) regardless of the particular format or state of the machine readable instructions and/or program(s) when stored or otherwise at rest or in transit.

The machine readable instructions described herein can be represented by any past, present, or future instruction language, scripting language, programming language, etc. For example, the machine readable instructions may be represented using any of the following languages: C, C++, Java, C #, Perl, Python, JavaScript, HyperText Markup Language (HTML), Structured Query Language (SQL), Swift, etc.

As mentioned above, the example operations of FIGS. 3-6 may be implemented using executable instructions (e.g., computer and/or machine readable instructions) stored on one or more non-transitory computer and/or machine readable media such as optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms non-transitory computer readable medium, non-transitory computer readable storage medium, non-transitory machine readable medium, and non-transitory machine readable storage medium are expressly defined to include any type of computer readable storage device and/or storage disk and to exclude propagating signals and to exclude transmission media. As used herein, the terms “computer readable storage device” and “machine readable storage device” are defined to include any physical (mechanical and/or electrical) structure to store information, but to exclude propagating signals and to exclude transmission media. Examples of computer readable storage devices and machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer readable instructions, machine readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements or method actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 3 is a flowchart representative of example machine-readable instructions and/or operations 300 which may be executed and/or instantiated by processor circuitry to implement the example numerical computation approximator circuitry 110 of FIG. 1. The machine readable instructions and/or the operations 300 of FIG. 3 begin at block 305, at which the input identifier circuitry 202 identifies input elements 305. In the example FIG. 3, the lookup table (LUT) generator circuitry 204 generates an element array (lookup table) tabulating function output (block 310), as described in connection with FIG. 4. In some examples, the index generator circuitry 206 indexes the lookup table using tensor values (block 315). In some examples, the output identifier circuitry 208 determines whether the output values should be directly output in a destination numeric format (block 320), such as when the downstream operators are reducing. If the output identifier circuitry 208 determines that the output values do not need to be in the destination numeric format, the lookup table (LUT) generator circuitry 204 outputs the lookup table for the compound set of functions(S) (block 325). In some examples, the input identifier circuitry 202 determines that the size of the input vectors is larger than the lookup address size (block 330). If the size of the input vectors is not larger than the lookup address size, then the softmax LUT determiner circuitry 210 performs softmax based LUT generation (block 335), as described in connection with FIG. 5. If the size of the input vectors is larger than the lookup address size, then the wide vector softmax LUT determiner circuitry 212 performs softmax based LUT generation for wide vectors (block 340), as described in connection with FIG. 6. The wide vector softmax LUT determiner circuitry 212 outputs the vector in destination numeric format (block 345).

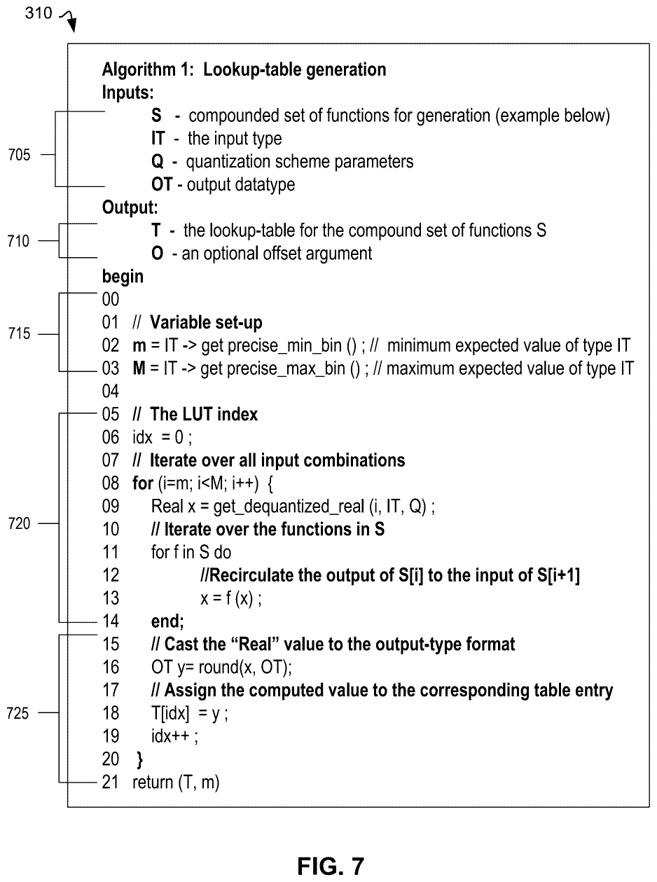

FIG. 4 is a flowchart representative of example machine-readable instructions and/or operations 310 which may be executed and/or instantiated by processor circuitry to implement the example lookup table generator circuitry 204 of FIG. 2. The machine readable instructions and/or the operations 310 of FIG. 4 begin at block 405, when the lookup table generator circuitry 204 retrieves input parameter(s) used to generate the lookup table (e.g., compounded set of functions(S), input type (IT), etc.). The lookup table generator circuitry 204 determines integer equivalent(s) of input type (IT) format bounds based on the input parameter(s) (block 410). In some examples, the integer equivalent(s) are determined using a function call such as get_precise_{min|max} _bin, as described in connection with FIG. 7. In some examples, the lookup table generator circuitry 204 determines dequantized real value(s) to convert a binary representation of i using the type information (e.g., input type) (e.g., using function get_dequantized_real (i, IT, Q)) (block 415). For example, the dequantized real value(s) can be determined using the quantization scheme information associated with the variable Q. The lookup table generator circuitry 204 iterates over the compound set of functions(S) using the determined dequantized real value to compute the output of each function (block 420). While all input points have not been processed (block 425), the lookup table generator circuitry 204 continues to iterate over the compound set of functions. Once all of the input points have been processed, the lookup table generator circuitry 204 outputs a lookup table with offset input values (block 430), as described in more detail in connection with FIG. 7.

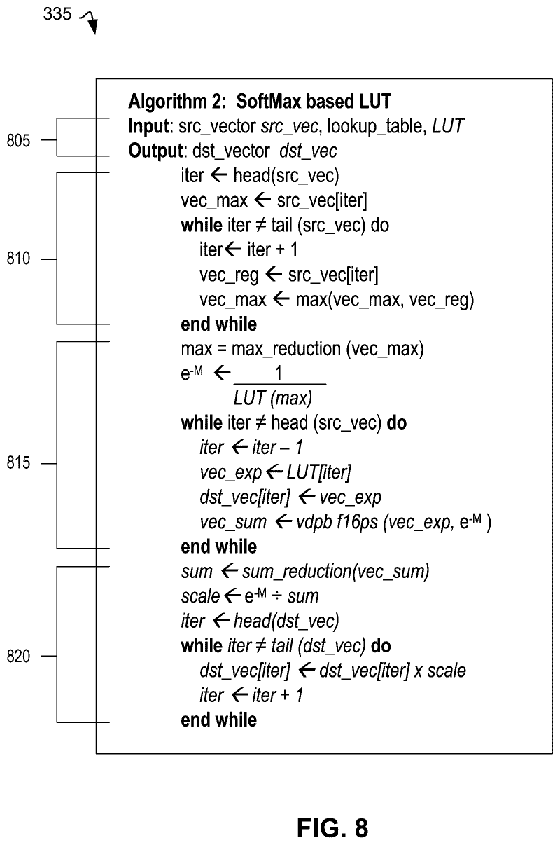

FIG. 5 is a flowchart representative of example machine-readable instructions and/or operations 335 which may be executed and/or instantiated by processor circuitry to implement the example softmax LUT determiner circuitry 210 performs of FIG. 2. The machine readable instructions and/or the operations 335 of FIG. 5 begin at block 505, when the softmax LUT determiner circuitry 210 retrieves relevant input(s) (e.g., generated lookup table). In some examples, the softmax LUT determiner circuitry 210 performs max reduction on input tensor(s) (block 510). For example, max reduction can be performed on 8-bit tensors, which are shown in connection with FIG. 8. In some examples, the softmax LUT determiner circuitry 210 performs lookup-based exponential implementation to avoid a complex datapath associated with numerical calculation of the softmax function (block 515). The softmax LUT determiner circuitry 210 further performs sum reduction (e.g., yielding a bit width of 16 bits for the reduced elements using a single instruction) (block 520). Once all input points are processed (block 525), the softmax LUT determiner circuitry 210 outputs a softmax-based lookup table (block 530), are shown in connection with FIG. 8.

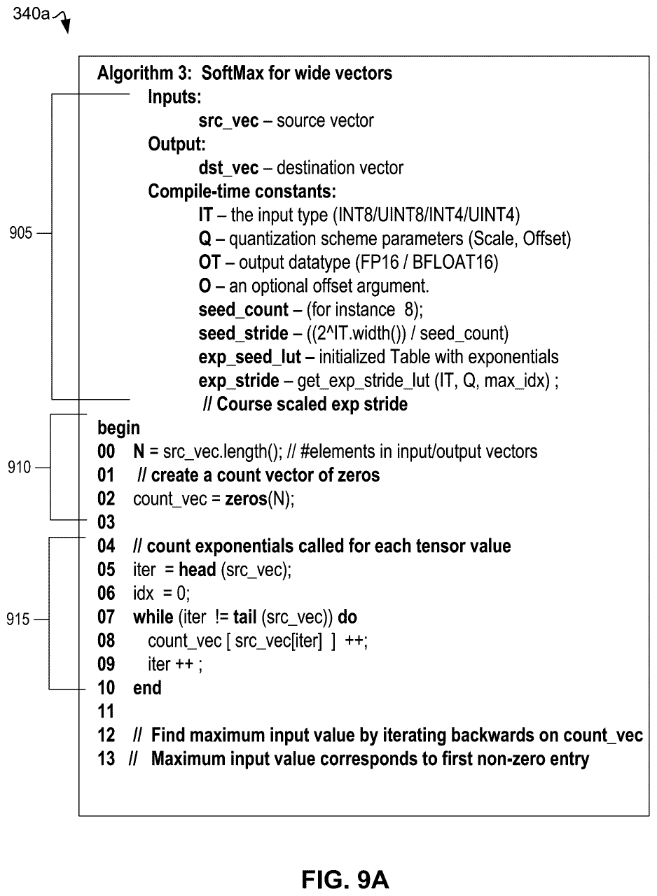

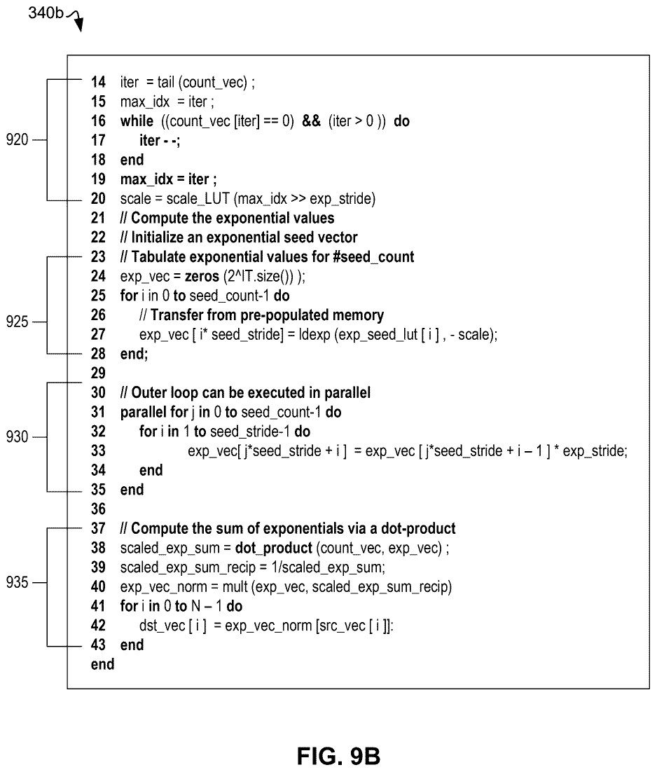

FIG. 6 is a flowchart representative of example machine-readable instructions and/or operations 340 which may be executed and/or instantiated by processor circuitry to implement the example wide vector softmax LUT determiner circuitry 212 of FIG. 2. The machine readable instructions and/or the operations 340 of FIG. 6 begin at block 605, when the wide vector softmax LUT determiner circuitry 212 identifies a source vector input. In some examples, the wide vector softmax LUT determiner circuitry 212 identifies compile time constants (block 610). For example, an input vector length can be identified as constant and be included in the list of compile time constraints. Subsequently, the wide vector softmax LUT determiner circuitry 212 determines the frequency of each input vector element within the input vector (block 615), as shown and described in connection with FIGS. 9A-9B. In some examples, the wide vector softmax LUT determiner circuitry 212 locates a maximum element of the input vector (block 620). For example, iterating backwards on count vector arrays previously populated and stopping at the first non-zero element can be used to identify the largest value of the input array. The wide vector softmax LUT determiner circuitry 212 performs scaling using coarse-scale normalization to check that no exponent value is too large to cause overflows, where scale value(s) are obtained using a table lookup (block 625). In some examples, the wide vector softmax LUT determiner circuitry 212 determines subsequent exponential values using subsequent multiplication (block 630), as described in more detail in connection with FIGS. 9A-9B. The wide vector softmax LUT determiner circuitry 212 determines the softmax denominator and denominator reciprocal output (block 635) (e.g., based on a dot-product call between a new scaled exponents vector and a corresponding counts vector). Based on the softmax denominator and denominator reciprocal output, the wide vector softmax LUT determiner circuitry 212 also determines exponential values in the destination vector (block 640), which are used to output a vector in destination numeric format.

FIG. 7 is an example of element array (e.g., lookup table) generation using the lookup table generator circuitry 204 of FIG. 2 in accordance with the machine-readable instructions 310 of FIGS. 3 and 4. In the example of FIG. 7, the lookup table generator circuitry 204 receives inputs at block 705 and identifies outputs at block 710. The lookup table generator circuitry 204 performs variable set-up based on the inputs, followed by determination of dequantized real values and iteration over the compound set of functions at block 720. The lookup table generator circuitry 204 completes the lookup table generation process by assigning computed values to a corresponding table entry at block 725 of FIG. 7, as described in more detail below.

For example, a lookup-table based technique can be used to implement a mapping between input and output elements of a computation. In the case of 8-bit input elements (e.g., corresponding to typical tensor bit-widths), a 2\hat{ }8=256 element array can be constructed that tabulates the function output. The tensor value (e.g., the 8-bit integer) is then used to index the table. FIG. 7 presents an example algorithm performed by the lookup table generator circuitry 204 for the lookup table generation procedure. For example, the algorithm inputs S, which is a set of functions that are to be composed to compute a given expression. For example, given the function g (x)=log(¾+exp(1−x)), the set of functions stored in S for function g are S={1−x, exp(x), ¾+x, log(x)}, where S[0]=1−x, S[1]=exp(x), etc. The algorithm also inputs IT, which denotes the quantized input type, representing anything from INT4 to UINT8 and to FP16. Alongside IT the algorithm inputs Q, which denotes the quantization scheme information. In some examples, for an affine transformation, this information could be composed of a scale parameter and a zero-offset parameter. Finally, the algorithm inputs the output type OT. This information is used for encoding the function output values in the desired format.

In the example of FIG. 7, the lookup table generator circuitry 204 initiates two variables m and M (lines 02-03). The function call get_precise_{min|max} _bin is used to identify integer equivalents of the IT format bounds. For INT8, although the supported range is [−128, 127], the values of the variables could be m=0 and M=255, whereas for bfloat16 the values could be m=0, M=(2\hat{ }16)−1. In practice, additional knowledge may be available that allows for the tightening of these bounds. Consequently, for INT8 iterating may be performed from m=47 to M=212. This may occur when symmetric quantization schemes are employed, where part of the output mapping does not map to valid (e.g., reachable) inputs. For instance, the range [−2,4] can map using a symmetric (e.g., zero-preserving) mapping onto [−128, 128]. However, due input range restrictions, values [−128, −64), which would map to [−4, −2), would go unused. Subsequently, at lines 08-20, the lookup table generator circuitry 204 performs iteration over the number valid entries corresponding to the quantized format. At line 09, dequantization of the value is initiated. The lookup table generator circuitry 204 uses a function (e.g., get_dequantized_real (i, IT, Q)) to convert the binary representation of i using the type information IT. Then, using the quantization scheme information provided in Q, the lookup table generator circuitry 204 determines the dequantized value. Furthermore, the returned value x is dequantized to a “real” format, which corresponds to a highly accurate format. Using the dequantized real value x, at lines 11-14 the lookup table generator circuitry 204 performs iteration over the functions stored in S to compute the output of each function one by one. For the first function that corresponds to S[0], the input is dequantized value x. The output of this function is then written back into x, becoming the input for the function S[1], and so on. An example is shown below of the evaluation of the function g (e.g., g(x)=log(¾+exp(1−x)) at point z:

$$y 0 = S [ 0 ] ( z ) ; // y 0 = 1 - z$$

$$y 1 = S [ 1 ] ( y 0 ) ; // y 1 = exp ( y 0 ) = exp ( 1 - z )$$

$$y 2 = S [ 2 ] ( y 1 ) ; // y 2 = 3 / 4 + y 1 = 3 / 4 + exp ( 1 - z )$$

$$y 3 = S [ 3 ] ( y 2 ) ; // y 3 = log ( y 2 ) = log ( 3 / 4 + exp ( 1 - z ) ) ;$$

In the example of FIG. 7, the input z corresponds to variable x, and the outputs y0 to y3 are also written back into the same “real” variable x. Finally, at line 16 of the algorithm, the lookup table generator circuitry 204 converts the computed function value to the nearest value representable on the output type. The result is then written into table T at index idx (e.g., these can be offset compared to the bounds m and M). Once all the input points have been processed, the lookup table generator circuitry 204 returns the lookup table T alongside an offset O that is set to m, allowing for sufficient information to potentially offset input values used in addressing this table.

In most non-computation operators, there still are many expensive calculations. In some examples, the exponential calculation takes the most time in a softmax operation. As described in connection with Equation 2, GELU is a non-computation-bound operator found in Natural Language Processing (NLP) models. Although compared to computationally intensive Conv/GEMM kernels, GELU can use significantly fewer Multiply-Accumulate (MAC) operations, yet it is still an important part of model inference time. For example, while an “erf” special function call is quite expensive, methods and apparatus disclosed herein allow replacing part of the erf calculation with a lookup table (e.g., or a combination of lookup tables and arithmetic operators, as described in more detail below). In some examples, the quantized input x is used to address the elements of the table. The table stores, at index i, the floating-point value corresponding to evaluating erf(dequantize(i)/sqrt(2)), thus absorbing multiplication by the reciprocal of sqrt(2). The new formula for Equation 2 is shown in connection with Equation 3:

$$GELU ( x ) = x / 2 ( 1 + LUT ( x ) ) \qquad Equation 3$$

Since erf(x)=>−1 as x=>−inf, for small values of the input, such as −2, the number of correct bits obtained in FP16 is only approximatively 5 (out of 11). Alternatively, tabulation of (1+erf(x/sqrt(2)))/2 can be performed using the same technique. In this case the accuracy improves significantly, as a single rounding error is performed as the tabulated value is stored. An increasingly better approach for this function is to extend the tabulation to the entire body of the function, as shown in connection with Equation 4:

$$GELU ( x ) = LUT\_ \{ GELU , HP \} ( x ) \qquad Equation 4$$

The tabulation absorbs all the computations, improves accuracy, and reduces operation count. As shown in more detail below, an approach where fewer tables are used and more arithmetic operations are implemented is also possible. This can be of increased importance in cases where tabulation cost becomes a bottleneck. Additionally, besides operators like GELU (e.g., which only has 1 input), operators taking more than 1 input can also benefit from methods and apparatus disclosed herein. For example, focal loss identifies and focuses on incorrect model predictions rather than the examples that the model confidently predicts, ensuring that the predictions on inaccurate examples improve overtime. Sigmoid focal loss can be considered as an example, as shown below:

$${{loss}_{i , j}}_{i ∈ [ 0 , ℕ - 1 ] , j ∈ [ 0 , ℂ - 1 ]} = \{ \begin{matrix}- \frac{1}{{f}_{{g}_{num}}} * α * {( 1 - σ ( {x}_{i , j} ) )}^{γ} * log ( σ ( {x}_{i , j} ) ) & ( j + 1 ) = {label}_{i , 0} \\ - \frac{1}{{f}_{{g}_{num}}} * ( 1 - α ) * {( {x}_{i , j} )}^{γ} * log ( 1 - σ ( {x}_{i , j} ) ) & ( j + 1 ) != {label}_{i , 0}\end{matrix}$$

$$σ ( {x}_{i , j} ) = \frac{1}{1 + exp ( - {x}_{i , j} )}$$

For example, the operator can be split into two parts, the “exp”, “log” calculation performed based on LUT for both of the two inputs, followed by “multiply” and “division” in the numerical methods. Compared with pure LUT, such a mixture of LUT as well as numerical calculation based on single instruction multiple data (SIMD) architecture is expected to cause less accuracy drop because LUTs only simulate a more naïve process instead of the whole mapping.

FIG. 8 is an example of softmax based lookup table generation using the softmax LUT determiner circuitry 210 of FIG. 1 in accordance with the machine-readable instructions 335 of FIGS. 3 and 5. In the example of FIG. 8, the softmax LUT determiner circuitry 210 receives inputs and determines the output formats at block 805. The softmax LUT determiner circuitry 210 then performs max reduction on input tensor(s) and lookup-based exponential implementation at blocks 810, 815, followed by sum reduction at block 820 to generate the softmax based LUT, as described in more detail below.

As previously mentioned, most lookup-based methods are typically limited to 8-bit input(s) and output(s). Since hardware can support some low-precision floating-point arithmetic (fp16/bf16), wider lookup tables can be used to directly output values in the destination numeric format and/or any type of format that is desired downstream of the tabulated operation. This is of particular interest for situations where the downstream operators are reducing, such as max/sum/mean, since these operators can be accelerated via advanced 16-bit floating-point SIMD instructions. Taking a softmax inference process as an example, a mixture LUT algorithm (e.g., based on Intel AVX512-bf16 ISA) can be performed as follows: In the first while-loop of FIG. 8, the softmax LUT determiner circuitry 210 performs max reduction on 8-bit input tensors (e.g., faster than traditional 32-bit). In some examples, the softmax LUT determiner circuitry 210 uses a lookup-based exponential implementation to avoid complex datapath(s) desired for a fp16/bfp16 numerical calculation of softmax. In the second while-loop of FIG. 8, the bit width of reduced elements is 16 bits when the softmax LUT determiner circuitry 210 performs sum reduction. Moreover, dot-product and sum operation can be executed through just one instruction (e.g., vdpbf16ps) within less cycle cost when compared with oneDNN.

FIGS. 9A-9B show an example of softmax based lookup table generation for wide vectors using the wide vector softmax LUT determiner circuitry 212 of FIG. 2 in accordance with the machine-readable instructions 340 of FIGS. 3 and 6. In the example of FIGS. 9A-9B, the wide vector softmax LUT determiner circuitry 212 identifies a source vector input and compile time constants at block 905, creates a count vector of zeros at block 910, and determines the frequency of each input vector element within the input vector at block 915. Additionally, the wide vector softmax LUT determiner circuitry 212 locates a maximum element of the input vector at block 920, performs scaling using coarse-scale normalization at block 925, determines subsequent exponential values using subsequent multiplication at block 930, and outputs exponential values in the destination vector at block 935, as described below in more detail.

In some examples, the softmax implementation can be sped up if the size of the input vectors is larger than the lookup-address size (e.g., if vector size is 512 elements and quantized INT8 data is being used). The softmax function inputs a vector of N elements and returns a vector of N elements. Each element j of the output array is computed as the ratio between the exponential value of the corresponding j element of the input array, and the sum of exponentials of all elements of the input array. FIGS. 9A-9B present an approach for computing the softmax function in cases where the number of elements of the input vector is at least 2× higher than the dynamic range corresponding to the input type width. For instance, if the input type is INT8 (which corresponds to 2\hat{ }8=256 elements), then the wide vector softmax LUT determiner circuitry 212 uses the algorithm shown in FIGS. 9A-9B for cases when N>=512. There are some distinctive features of this algorithm, including that instead of computing the exponential for each element of the input array, the algorithm calculates the number of times each exponential needs to be computed. Furthermore, the exponentials are computed for all possible tensor values. The process is incremental, and given the exponential for a tensor value i (exp(dequantize(i)), the exponential for i+1=exp(dequantize(i+1))=exp(dequantize(i)+dequantize(1))=exp(dequantize(i))*exp(dequantize(1)) can be obtained. For example, a multiplication by what is a constant exp(dequantize(1)) can be used to obtain the subsequent exponential value.

In the example of FIG. 9A, the wide vector softmax LUT determiner circuitry 212 sets N to the input vector length (line 00). If this value is known to be constant ahead of time, then the value can be part of the compile-time constants. The softmax LUT determiner circuitry 210 then handles counting the number of times each input vector element is found within the input vector (lines 01-10). This implementation is simplified knowing that input element type (e.g., the tensor type) will be a relatively short type (e.g., such as UINT8). A vector (e.g., count_vec) having 2\hat{ }w elements (e.g., where w is the input type width and w=8=>256 elements for UINT8) is created and is initialized with 0. Next, the softmax LUT determiner circuitry 210 performs looping over the element of the input vector. For element j=src_vec[i], the counting vector is implemented as count_vec[j]=count_vec[j]+1. Subsequently, the softmax LUT determiner circuitry 210 locates the maximum element of the input vector (lines 12-19). This is achieved by iterating backwards on the count_vec array previously populated while stopping at the first non-zero element. As such, the index j of the element for which count_vec[j]!=0 is the largest value of the input array.

The softmax LUT determiner circuitry 210 proceeds with population of #seed exponential values (e.g., uniformly spaced) in the exp_vec array by identifying exponential values in a pre-computed table (lines 21-28). The distance between two seeded values is identified as seed_stride. The seed values are scaled down by scale, which represents an integer power of two. The scaling accomplishes a coarse-scale normalization, so that no exponent value is too large to cause overflows. In some examples, the scaling is implemented via ldexp calls. For example, the softmax LUT determiner circuitry 210 obtains the scale value by means of a table lookup. Each #seed_stride has a single scale stored for the entire range. Starting from a seed value and a constant exp_stride (e.g., pre-computed and static for a given quantization scheme), the softmax LUT determiner circuitry 210 computes the subsequent seed_stride−1 exponential values by subsequent multiplication. In some examples, the outer loop (line 31) has no data dependencies between iterations and can therefore be executed in parallel. In some examples, the softmax denominator (sum of exponentials) is computed by means of a dot-product call between the new scaled exponents vector (exp_vec) and the corresponding counts (count_vec), thereby ensuring that the dot-product does not overflow the range of the floating-point format. The softmax LUT determiner circuitry 210 determines the denominator reciprocal (line 39), and the denominator reciprocal is multiplied by all elements of the exp_vec array (line 40). In the example of FIG. 9B, the final loop (lines 41-43) produces the final exponential values in the destination vector by copying the values from the exp_vec_norm. In some examples, the size of the destination vector is N (e.g., matching that of the input vector), which does not typically match the size of the exp_vec array given that this array is shorter. Consequently, for output index i, the softmax LUT determiner circuitry 210 obtains the tensor value in the source vector and this value is used to fetch the output value from the exp_vec_norm array.

In some examples, function implementation based on lookup-based techniques can be performed. As previously described, a single lookup table can be used to tabulate all possible function outputs for a given input type. The particularities of this approach consist in the fact that the table input is a quantized (e.g., tensor) value which has a low bit-width (e.g., such as 8 bits for INT8), whereas the outputs of the table could be anything from a quantized INT8, to an FP16, bfloat16, or even FP32. In examples disclosed herein, reduction of the total tabulation size, at the expense of some simple arithmetic operations (e.g., typically available in silicon in modern processors), can be achieved. This has the potential of alleviating potential cache pressure caused by the large array size that needs to be fetched from memory. Such a technique is introduced in a context where one input of the implementation is a quantized format and the output is a floating-point format (e.g., FP16, bfloat16, FP32, etc.). In particular, methods and apparatus disclosed herein involve replacing the single table with several tables, where each table stores coefficient data. Although more tables are used, the number of entries in each table is greatly reduced, which ultimately reduces the number of tabulated bits in the implementation. The major differences to a “typical” polynomial-approximation based technique is the fact that (1) the inputs are not de-quantized for the polynomial approximation and (2) the polynomial approximation is tuned so that creating a floating-point input from the INT8/UINT8 quantized input is trivial and does not need special conversion hardware. In examples disclosed herein, the exponential function is used where the input before quantization is [−4, 4] and quantization uses an 8-bit format. Such a method is generic and adapts to other functions (e.g., such as the erf/erfc implementations).

FIG. 10 shows example results for two matrix sizes that illustrate the reduction of system performance using non-linear function calls, as described in more detail in connection with FIG. 1. For example, table 1000 presents the performance (e.g., reported in GFLOPS) measured on the SPR kernel (e.g., performing a rank-1 update of a symmetric packed matrix) using different non-linear functions for each output element. The table 1000 reports numbers for two matrices 1005 (e.g., matrix sizes (N, P, Q) with A (N, P) and B (P, Q), where Size [0]=(256, 768, 768) and Size [1]=(256, 2048, 1024)). In the illustrated example of FIG. 10, the functions used include Pure IP 101, GELU 1015, Hardswish 1020, Logsimoid 1025, and SQRT 1030.

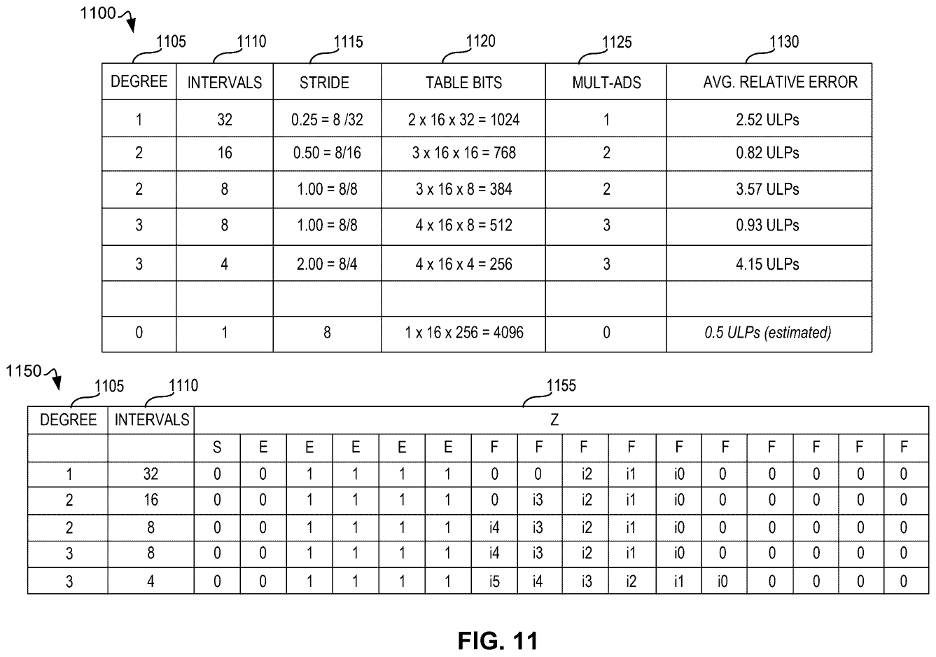

FIG. 11 illustrates example tabulation and compute identifiers alongside an average relative error and an example polynomial argument creation based on quantized input bits for the implementation associated with the tabulation and compute identifiers shown. Considering a range sub-division, the initial input range can be split into 32 uniform subintervals. The size of an interval, denoted by stride, is defined as stride= 8/32=¼. For sub-interval index i, the input range spawned can be defined as [i*stride, (i+1)*stride]. When approximating f(x) on interval index i by a polynomial P, instead of using the absolute x to address the polynomial, an input relative to the interval [0, stride] can be used. Therefore, when approximating f(x) on [i*stride, (i+1)*stride], approximation of f(y+i*stride) is performed for y in [0, stride]. Moreover, working with a quantized input can be costly to convert the INT8 into the corresponding value in the [0, stride] interval. Therefore, instead of approximating f(y+i*stride) for y in [0, stride], approximation of f(z−1+i*stride) is performed for z in [1, 1+stride]. This transformation allows for identification of z from the quantized format by only using basic operations, as previously shown. Table 1100 of FIG. 11 summarizes the tabulation and compute identifiers alongside the average relative error for several instantiations of this method for the input interval [−4,4]. In the example of FIG. 11, table 1100 includes a degree listing 1105, an interval listing 1110, a calculated stride 1115, table bits 1120, multiply add calls 1125, and average relative error 1130. The table 1100 exemplifies that several tradeoffs between compute (e.g., number of multiply-add operations) and tabulation size (e.g., number of tabulated bits) are possible, and each of these implementations expose different relative error bounds (e.g., the lower the value, the more accurate the implementation). Table 1150 of FIG. 1100 includes the listing of degrees 1105 and intervals 1100, as well as the z values 1155. Table 1150 further exemplifies the polynomial argument creation based on the quantized input bits for the implementations described above (e.g., where different number of subintervals are used).

FIG. 12 illustrates example results associated with piecewise-polynomial and range-reduction for degree-d approximation based on quantized input data in accordance with teachings disclosed herein. In the example of FIG. 12, table 1200 includes interval index value(s) 1202, interval(s) 1205, Interval/log(2) calculation(s) 1210, E value(s) 1215, Y=Interval−log(2)E calculation value(s) 1220, and offset value(s) 1224, as described below in more detail. In particular, a piecewise-polynomial and range-reduction for degree-d approximation is performed based on quantized input data. For example, quantized-data-based range-reduction can be integrated into methods disclosed herein. This allows increasing the supported data range as well as providing more accurate implementation results (e.g., specific to the exponential function). The proposed range reduction is based on the following: Letting x be the input to the exponential function and letting x be expressed as x=E*log 2+y, where E is the closest integer to x/log(2), and y will be some value in the interval [−log 2/2, log 2/2]. Computing the exponential in floating-point results in exp(x)=exp(E*log 2+y)=exp(E*log 2)*exp(y)=2\hat{ }E*exp(y). Since y will be relatively small (e.g., approximately [−0.34, 0.34]), exp(y) will also have a narrow range (e.g., approximately [0.7, 1.41]), which may call for an exponent update (e.g., decrement) if exp(y) is smaller than 1. In examples shown below, the same input interval [−4, 4] is used, split into 16 subintervals, with each subinterval of size 0.5 (e.g., computed as the range (4−(−4))/16).

In the example of FIG. 12, the first column of table 1200 shows the interval index 1202 (e.g., ranging from 0 to 15). The second column shows the input range (e.g., interval 1205) that corresponds to the interval index 1202 on the left. The third column of table 1200 shows the quotient produced by dividing the interval 1205 in the second column by the constant log(2) (e.g., Interval/log(2) calculation(s) 1210), while the fourth column shows the custom E value(s) 1215. For example, for negative intervals, E can be computed using ceil (sup (I/log(2)), while for positive intervals, E can be computed using floor (inf(I/log(2)). The fifth column of table 1200 shows the range of I-log(2) E 1220 (e.g., the range-reduced input for the exponential). Finally, the sixth column shows the offset 1225, which is the left-bound of the intervals computed in the previous column. For each interval, a pre-determined value of E is identified and tabulated. Since the range of E is [−5, 5], a format with 4 integer bits can suffice. Wider supported input ranges can yield larger values of E, and therefore this range can be increased. Regarding the computation of exp(y), where y is shown in the fifth column, the following identity can be used: e\hat{ }(a+b)=e\hat{ }(a)*e\hat{ }(b). In the calculation of exp(y), the arguments above can be expressed as e\hat{ }(offset+[0, 0.5])=e\hat{ }(offset)*e\hat{ }([0, 0.5]). The value of e\hat{ }(offset) can be tabulated for all the 16 input intervals, with the exponential calculated over the interval [0, 0.5].

As such, the proposed approach may need 4-bit*16=64 bits for the tabulated E values, 16-bit*16=256 bits for the tabulated exp(offset) values, and 3 (coefficients)*16=48 bits for the degree-2 polynomial coefficients used for approximating exp(z) for z in [0, 0.5]. In total, the architecture uses (4+16)*16+3*16=320+48=368 bits for tabulation. Additionally, the polynomial evaluation uses two multiply add operations (e.g., for evaluating the degree-2 polynomial using Horner's scheme), one LDEXP operation (e.g., for adding E onto the tabulated offset exponential), and one multiplication to assemble the final result. The upper 4 bits are used in the address decoding: address=0xF & (input>>4). The function exp(x) is approximated for x in [0, 0.5]. In examples disclosed herein, the function exp(z−1) is approximated for z in [1, 1.5]. This transformation allows creation of z by populating the lower 4 bits of the input into a floating-point value, as shown below:

| S | E | E | E | E | E | F | F | F | F | F | F | F | F | F | F |
|---|---|---|---|---|---|---|---|---|---|---|---|---|---|---|---|
| 0 | 0 | 1 | 1 | 1 | 1 | 0 | i3 | i2 | i1 | i0 | 0 | 0 | 0 | 0 | 0 |

In some examples, the exponent value is obtained from a lookup, where E=e_table[address] is used to identify the integer value (e.g., 4 bits). An offset_exponential value is computed as an exponential on the rightmost column in the range-reduction table 1200 mentioned above, as follows: offset_exp=offset_table[address] representing the floating-point (e.g., half-precision) value. Finally, a single degree-2 polynomial is obtained: p=(a2*z+a1)*z+a0. The polynomial p is 0.6435546875*x\hat{ }2+−0.3154296875*x+0.6728515625 and the final value is computed as out=LDEXP(offset_exp, E)*p.

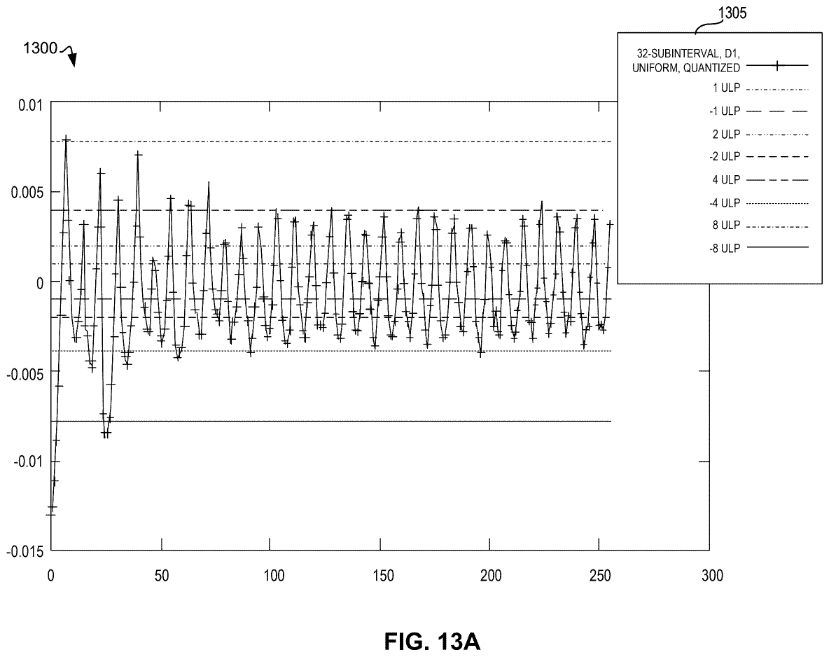

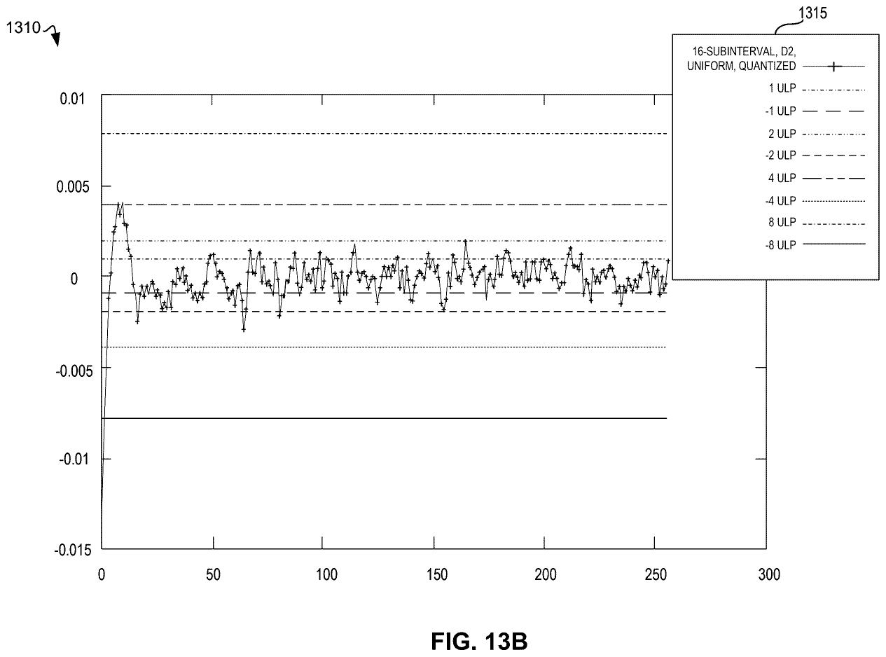

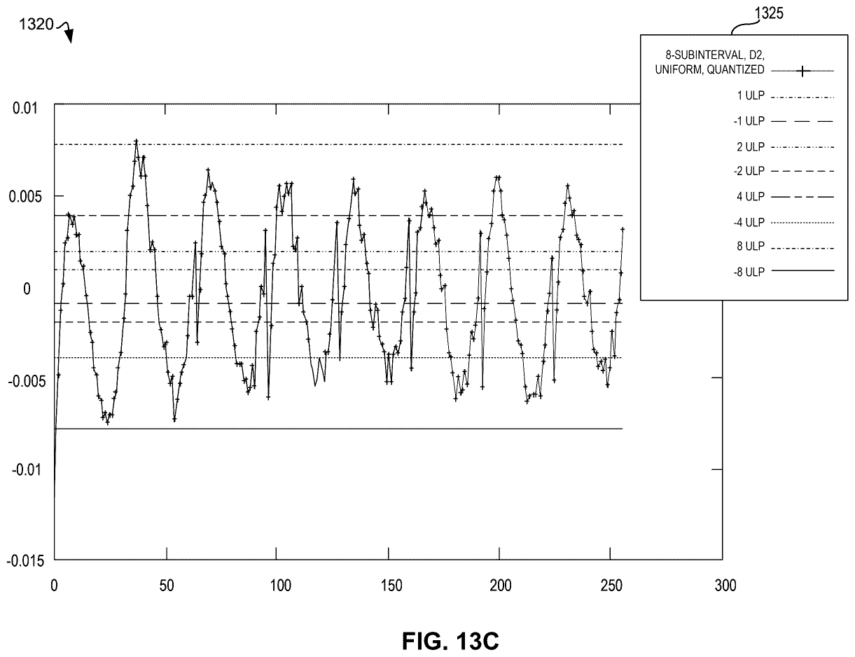

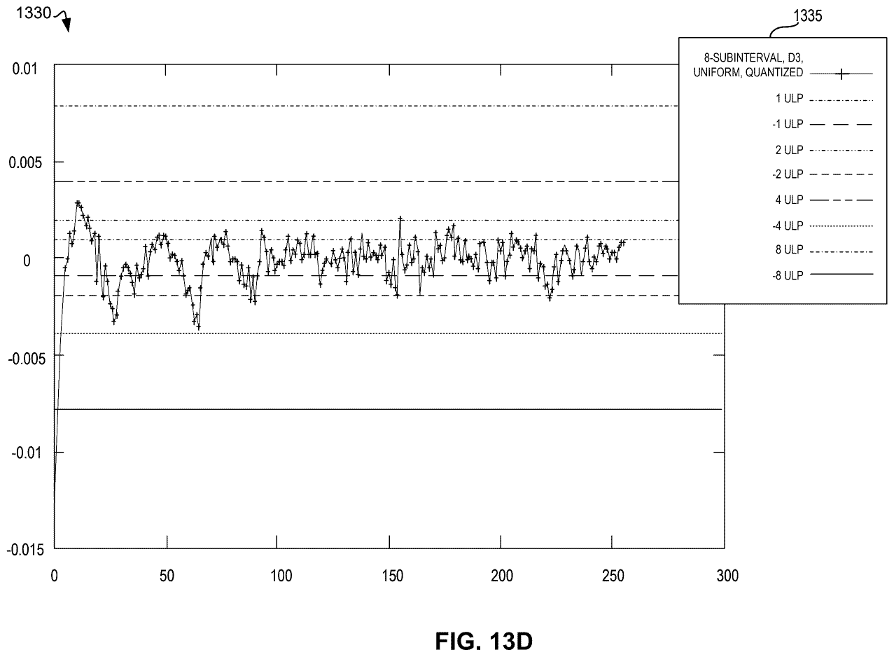

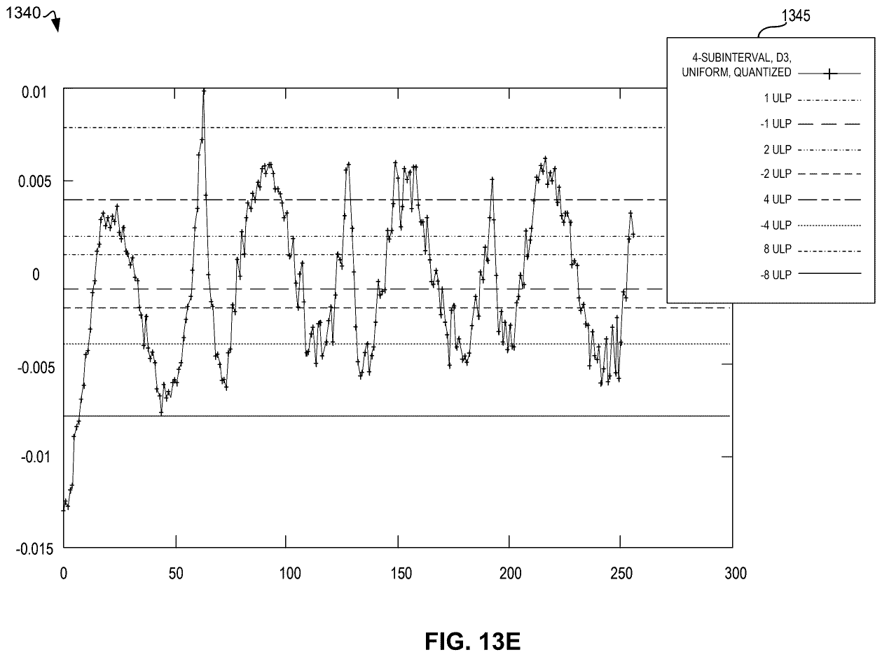

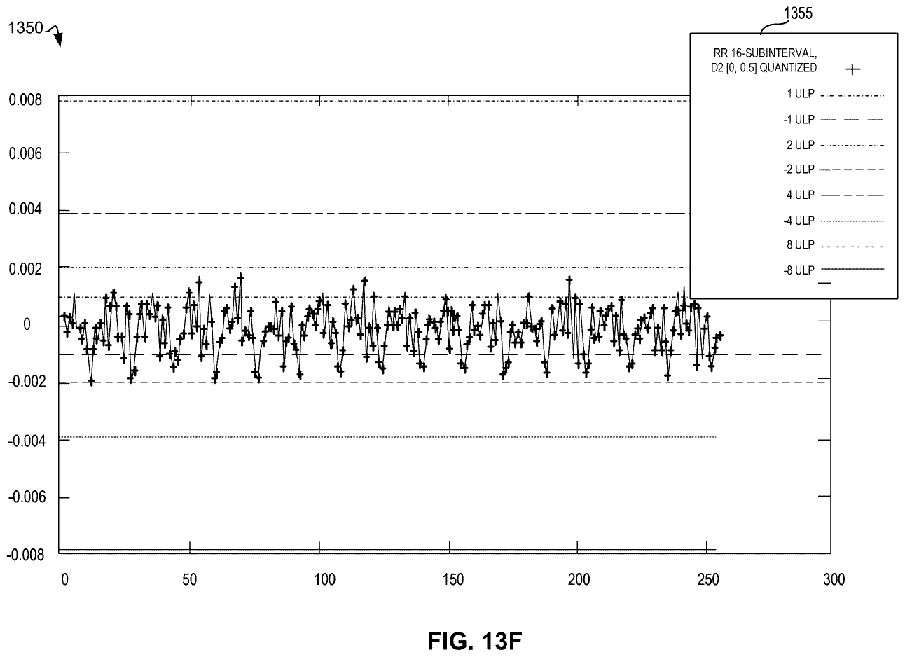

FIGS. 13A-13F illustrate example graphical representations 1300, 1310, 1320, 1330, 1340 1350 of the relative error associated with the tabulated results of FIGS. 11-12. The figures show the relative error for the degree 2 and degree 3 implementations in the tables above, for the corresponding number of sub-intervals given in the tables (e.g., based on units in last place (ULPs) ranging from −8 ULP to 1ULP, as shown in tables 1305, 1315, 1325, 1335, 1345, 1355). In some examples, piecewise-polynomial degree-d approximation can be performed based on quantized input data. For example, for a degree-1 approximation, two coefficients are used, and the polynomial is of the form P (x)=a0+a1*x. For an input interval sub-divided into 32 sub-intervals, FIG. 13A shows the relative error of the implementation, highlighting that the relative error is typically bounded by 4 ULPs, and the average relative error is 2.52ULPs. The subinterval index is simply obtained from the quantized input by analyzing the upper 5 bits using address=0x1F & (input>>3). The coefficient tables table_a0[ ] and table_a1[ ] output data in the floating-point format (e.g., half-precision). The corresponding coefficients are obtained by using the address variable to index these tables: a0=table_a0[address]; a1=table_a1[address]. Next, a floating-point polynomial input can be obtained by manipulating the input data as follows: z=0x3C00| ((input & 0x7)<<5). This expression first creates a floating-point fraction from the lower bits of inputs by concatenating 5 zeros to the right and 2 zeros to the left. Next, the exponent corresponding to power 2\hat{ }0 (e.g., “01111” in binary) is concatenated to the left of the fraction. The constant (e.g., expressed in hexadecimal) 0x3C00 can be used for concatenating the “01111” exponent and a sign of “0” to the newly created fraction using bitwise OR operations. The resulting input (e.g., in half-precision) is shown in the example below:

| S | E | E | E | E | E | F | F | F | F | F | F | F | F | F | F |
|---|---|---|---|---|---|---|---|---|---|---|---|---|---|---|---|
| 0 | 0 | 1 | 1 | 1 | 1 | 0 | 0 | i2 | i1 | i0 | 0 | 0 | 0 | 0 | 0 |

The polynomial evaluation is therefore implemented using a simple multiply-add operation in half-precision (e.g., p=a1*z+a0).

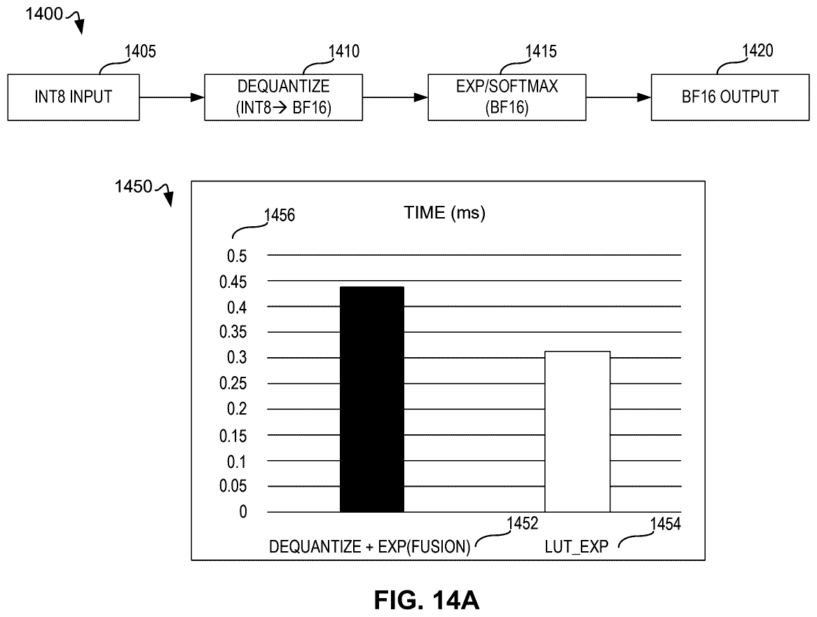

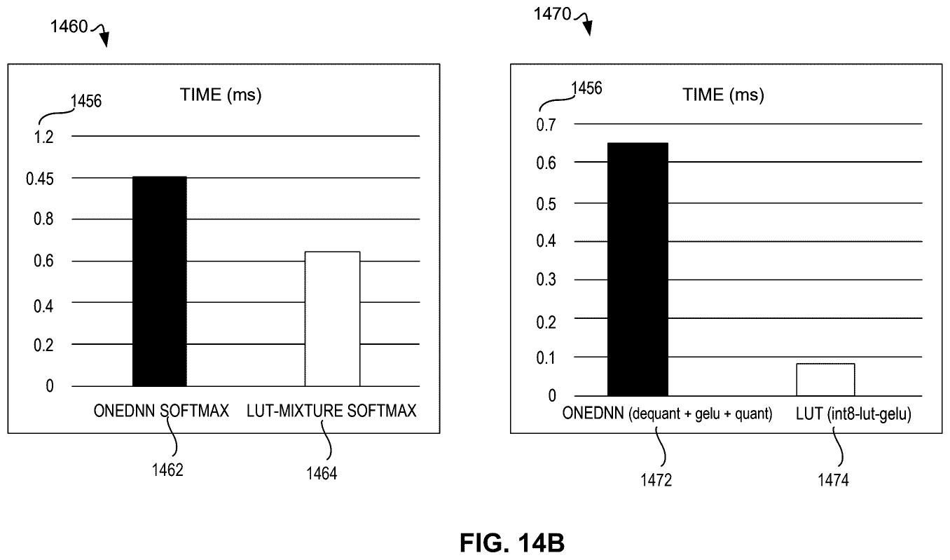

FIGS. 14A-14B include an example computational graph 1400 used in low-precision training and example performance data graphs 1450, 1460, 1470 associated with pure-eltwiseop exp, eltwiseop-intensive non-computation-bound op softmax, and a GELU activation function. In examples disclosed herein, to validate performance and accuracy, a pure-eltwiseop exp is compared to an eltwiseop-intensive non-computation-bound op softmax both from oneDNN. The two implementations can be benchmarked (e.g., using Intel Xeon Sapphire Rapids), where the config is a 1024×1024 input shape, single-core single-thread. The related computational graph 1400 is a widely used low-precision training/inference scenario, which takes int8 as example input 1405, applies an example dequantization block 1410 (e.g., converts the INT8 to floating-point format), and applies an example non-computation-bound op block 1415 (e.g., exp, softmax, etc.) to produce an example output 1420. In some examples, dequantize and exp blocks 1410, 1415 are both pure-eltwise operations, so the op-fusion optimization is applied in oneDNN, such that the exp operator can be benchmarked, as shown in connection with computational graph 1400. The benchmark results shown below demonstrate that the LUT-based implementation of the exponential disclosed herein can improve performance without sacrificing accuracy. In terms of accuracy, the mean square error (MSE) is used to model the loss function, the results shown below indicating that methods disclosed herein can obtain the same accuracy compared to oneDNN:

| operator | MSE (oneDNN vs methods disclosed herein) |
|---|---|
| GELU | 0 |
| softmax | 0 |

Performance data for the pure-eltwiseop exp is shown in connection with graph 1450, performance data for the eltwiseop-intensive non-computation-bound op softmax is shown in connection with graph 1460, and performance data for the GELU activation function with different implementations (e.g., oneDNN and methods disclosed herein) is shown in connection with graph 1470. For example, graph 1450 shows performance data over time 1456 for dequantize with exp(fusion) 1452 compared to LUT_exp 1454, graph 1460 shows performance data over time 1456 for oneDNN softmax 1462 compared to LUT mixture softmax 1464, and graph 1470 shows performance data over time 1456 for oneDNN (dequant+GELU+quant) 1472 compared to LUT (int8-LUT-GELU) 1474. For the exponential implementation, when comparing the proposed lookup-based solution (e.g., INT8 input, BFP16 output) against the oneDNN dequantize call (e.g., INT8->BFP16) followed by a BFP16 exponential call, the implementation disclosed herein indicates a 1.3× processing speed improvement (e.g., 1.3× less compute time), as shown in connection with graph 1450. On the softmax benchmark, the performance gain widens in favor of the lookup-based implementation (e.g., 1.56×), as shown in connection with graph 1460. This increase in performance can be attributed to the efficient utilization of the low-precision related ISA combined with the lookup-based exponential implementation disclosed herein. The lookup-based approach is also benchmarked on the GELU activation function, which is a key operator for BERT models. The following operator chain is considered: dequantize, followed by GELU call, followed by (re) quantization. The input datatype is INT8, dequantization converts the data to the FP32 floating-point format for the GELU calculation, and finally, the FP32 output of the GELU call is converted back (e.g., quantized) to the INT8 datatype. In this flow, the lookup-based approach shows significant improvement, with the total compute time reduced by roughly 8×, as shown in connection with graph 1470.

FIG. 15 is a block diagram of an example processor platform 1500 structured to execute and/or instantiate the machine readable instructions and/or operations of FIGS. 3-6 to implement the example numerical computation approximator circuitry 110. The processor platform 1500 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset (e.g., an augmented reality (AR) headset, a virtual reality (VR) headset, etc.) or other wearable device, or any other type of computing device.

The processor platform 1500 of the illustrated example includes processor circuitry 1512. The processor circuitry 1512 of the illustrated example is hardware. For example, the processor circuitry 1512 can be implemented by one or more integrated circuits, logic circuits, FPGAs microprocessors, CPUs, GPUs, DSPs, and/or microcontrollers from any desired family or manufacturer. The processor circuitry 1512 may be implemented by one or more semiconductor based (e.g., silicon based) devices. In this example, the processor circuitry 1512 implements the input identifier circuitry 202, the lookup table (LUT) generator circuitry 204, the index generator circuitry 206, the output identifier circuitry 208, the softmax LUT determiner circuitry 210, and the wide vector softmax LUT determiner circuitry 212.

The processor circuitry 1512 of the illustrated example includes a local memory 1513 (e.g., a cache, registers, etc.). In the example of FIG. 15, the local memory 1513 implements the example data storage 214 of FIG. 2. However, any of the example memories 1514, 1516 may implement all or part of the example data storage 214 of FIG. 2. The processor circuitry 1512 of the illustrated example is in communication with a main memory including a volatile memory 1514 and a non-volatile memory 1516 by a bus 1518. The volatile memory 1514 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1516 may be implemented by flash memory and/or any other desired type of memory device. Access to the main memory 1514, 1516 of the illustrated example is controlled by a memory controller 1517.

The processor platform 1500 of the illustrated example also includes interface circuitry 1520. The interface circuitry 1520 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1522 are connected to the interface circuitry 1520. The input device(s) 1522 permit(s) a user to enter data and/or commands into the processor circuitry 1512. The input device(s) 1522 can be implemented by, for example, an audio sensor, a microphone, a camera (still or video), a keyboard, a button, a mouse, a touchscreen, a track-pad, a trackball, an isopoint device, and/or a voice recognition system.

One or more output devices 1524 are also connected to the interface circuitry 1520 of the illustrated example. The output devices 1524 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1520 of the illustrated example, thus, typically includes a graphics driver card, a graphics driver chip, and/or graphics processor circuitry such as a GPU.

The interface circuitry 1520 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1526. The communication can be by, for example, an Ethernet connection, a digital subscriber line (DSL) connection, a telephone line connection, a coaxial cable system, a satellite system, a line-of-site wireless system, a cellular telephone system, an optical connection, etc.

The processor platform 1500 of the illustrated example also includes one or more mass storage devices 1528 to store software and/or data. Examples of such mass storage devices 1528 include magnetic storage devices, optical storage devices, floppy disk drives, HDDs, CDs, Blu-ray disk drives, redundant array of independent disks (RAID) systems, solid state storage devices such as flash memory devices, and DVD drives.

The machine executable instructions 1532, which may be implemented by the machine readable instructions of FIGS. 3-6, may be stored in the mass storage device 1528, in the volatile memory 1514, in the non-volatile memory 1516, and/or on a removable non-transitory computer readable storage medium such as a CD or DVD.

FIG. 16 is a block diagram of an example implementation of the processor circuitry 1512 of FIG. 15. In this example, the processor circuitry 1512 of FIG. 15 is implemented by a microprocessor 1600. For example, the microprocessor 1600 may be a general purpose microprocessor (e.g., general purpose microprocessor circuitry). The microprocessor 1300 executes some or all of the machine readable instructions of the flowcharts of FIGS. 3-6 to effectively instantiate the circuitry of FIG. 2 logic circuits to perform the operations corresponding to those machine readable instructions. In some such examples, the circuitry of FIG. 2 is instantiated by the hardware circuits of the microprocessor 1600 in combination with the instructions. For example, the microprocessor 1600 may implement multi-core hardware circuitry such as a CPU, a DSP, a GPU, an XPU, etc. Although it may include any number of example cores 1602 (e.g., 1 core), the microprocessor 1600 of this example is a multi-core semiconductor device including N cores. The cores 1602 of the microprocessor 1600 may operate independently or may cooperate to execute machine readable instructions. For example, machine code corresponding to a firmware program, an embedded software program, or a software program may be executed by one of the cores 1602 or may be executed by multiple ones of the cores 1602 at the same or different times. In some examples, the machine code corresponding to the firmware program, the embedded software program, or the software program is split into threads and executed in parallel by two or more of the cores 1602. The software program may correspond to a portion or all of the machine readable instructions and/or operations represented by the flowcharts of FIGS. 3-6.

The cores 1602 may communicate by an example bus 1604. In some examples, the bus 1604 may implement a communication bus to effectuate communication associated with one(s) of the cores 1602. For example, the bus 1604 may implement at least one of an Inter-Integrated Circuit (I2C) bus, a Serial Peripheral Interface (SPI) bus, a PCI bus, or a PCIe bus. Additionally or alternatively, the bus 1604 may implement any other type of computing or electrical bus. The cores 1602 may obtain data, instructions, and/or signals from one or more external devices by example interface circuitry 1606. The cores 1602 may output data, instructions, and/or signals to the one or more external devices by the interface circuitry 1606. Although the cores 1602 of this example include example local memory 1620 (e.g., Level 1 (L1) cache that may be split into an L1 data cache and an L1 instruction cache), the microprocessor 1600 also includes example shared memory 1610 that may be shared by the cores (e.g., Level 2 (L2_cache)) for high-speed access to data and/or instructions. Data and/or instructions may be transferred (e.g., shared) by writing to and/or reading from the shared memory 1610. The local memory 1620 of each of the cores 1602 and the shared memory 1610 may be part of a hierarchy of storage devices including multiple levels of cache memory and the main memory (e.g., the main memory 1514, 1516 of FIG. 15). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1602 may be referred to as a CPU, DSP, GPU, etc., or any other type of hardware circuitry. Each core 1602 includes control unit circuitry 1614, arithmetic and logic (AL) circuitry (sometimes referred to as an ALU) 1616, a plurality of registers 1618, the L1 cache 1620, and an example bus 1622. Other structures may be present. For example, each core 1602 may include vector unit circuitry, single instruction multiple data (SIMD) unit circuitry, load/store unit (LSU) circuitry, branch/jump unit circuitry, floating-point unit (FPU) circuitry, etc. The control unit circuitry 1614 includes semiconductor-based circuits structured to control (e.g., coordinate) data movement within the corresponding core 1602. The AL circuitry 1616 includes semiconductor-based circuits structured to perform one or more mathematic and/or logic operations on the data within the corresponding core 1602. The AL circuitry 1616 of some examples performs integer-based operations. In other examples, the AL circuitry 1616 also performs floating point operations. In yet other examples, the AL circuitry 1616 may include first AL circuitry that performs integer-based operations and second AL circuitry that performs floating point operations. In some examples, the AL circuitry 1616 may be referred to as an Arithmetic Logic Unit (ALU). The registers 1618 are semiconductor-based structures to store data and/or instructions such as results of one or more of the operations performed by the AL circuitry 1616 of the corresponding core 1602. For example, the registers 1618 may include vector register(s), SIMD register(s), general purpose register(s), flag register(s), segment register(s), machine specific register(s), instruction pointer register(s), control register(s), debug register(s), memory management register(s), machine check register(s), etc. The registers 1618 may be arranged in a bank as shown in FIG. 16. Alternatively, the registers 1618 may be organized in any other arrangement, format, or structure including distributed throughout the core 1602 to shorten access time. The second bus 1622 may be implemented by at least one of an I2C bus, a SPI bus, a PCI bus, or a PCIe bus.

Each core 1602 and/or, more generally, the microprocessor 1600 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1600 is a semiconductor device fabricated to include many transistors interconnected to implement the structures described above in one or more integrated circuits (ICs) contained in one or more packages. The processor circuitry may include and/or cooperate with one or more accelerators. In some examples, accelerators are implemented by logic circuitry to perform certain tasks more quickly and/or efficiently than can be done by a general purpose processor. Examples of accelerators include ASICs and FPGAs such as those discussed herein. A GPU or other programmable device can also be an accelerator. Accelerators may be on-board the processor circuitry, in the same chip package as the processor circuitry and/or in one or more separate packages from the processor circuitry.

FIG. 17 is a block diagram of another example implementation of the processor circuitry of FIG. 15. In this example, the processor circuitry 1512 is implemented by FPGA circuitry 1700. For example, the FPGA circuitry 1700 may be implemented by an FPGA. The FPGA circuitry 1700 can be used, for example, to perform operations that could otherwise be performed by the example microprocessor 1600 of FIG. 16 executing corresponding machine readable instructions. However, once configured, the FPGA circuitry 1700 instantiates the machine readable instructions in hardware and, thus, can often execute the operations faster than they could be performed by a general purpose microprocessor executing the corresponding software.

More specifically, in contrast to the microprocessor 1600 of FIG. 16 described above (which is a general purpose device that may be programmed to execute some or all of the machine readable instructions represented by the flowcharts of FIGS. 3-6 but whose interconnections and logic circuitry are fixed once fabricated), the FPGA circuitry 1700 of the example of FIG. 17 includes interconnections and logic circuitry that may be configured and/or interconnected in different ways after fabrication to instantiate, for example, some or all of the machine readable instructions represented by the flowcharts of FIGS. 3-6. In particular, the FPGA 1700 may be thought of as an array of logic gates, interconnections, and switches. The switches can be programmed to change how the logic gates are interconnected by the interconnections, effectively forming one or more dedicated logic circuits (unless and until the FPGA circuitry 1700 is reprogrammed). The configured logic circuits enable the logic gates to cooperate in different ways to perform different operations on data received by input circuitry. Those operations may correspond to some or all of the software represented by the flowcharts of FIGS. 3-6. As such, the FPGA circuitry 1700 may be structured to effectively instantiate some or all of the machine readable instructions of the flowcharts of FIGS. 3-6 as dedicated logic circuits to perform the operations corresponding to those software instructions in a dedicated manner analogous to an ASIC. Therefore, the FPGA circuitry 1700 may perform the operations corresponding to the some or all of the machine readable instructions of FIGS. 3-6 faster than the general purpose microprocessor can execute the same.

In the example of FIG. 17, the FPGA circuitry 1700 is structured to be programmed (and/or reprogrammed one or more times) by an end user by a hardware description language (HDL) such as Verilog. The FPGA circuitry 1700 of FIG. 17, includes example input/output (I/O) circuitry 1702 to obtain and/or output data to/from example configuration circuitry 1704 and/or external hardware 1706. For example, the configuration circuitry 1704 may implement interface circuitry that may obtain machine readable instructions to configure the FPGA circuitry 1700, or portion(s) thereof. In some such examples, the configuration circuitry 1704 may obtain the machine readable instructions from a user, a machine (e.g., hardware circuitry (e.g., programmed or dedicated circuitry) that may implement an Artificial Intelligence/Machine Learning (AI/ML) model to generate the instructions), etc. In some examples, the external hardware 1706 may be implemented by external hardware circuitry. For example, the external hardware 1706 may be implemented by the microprocessor 1700 of FIG. 17. The FPGA circuitry 1700 also includes an array of example logic gate circuitry 1708, a plurality of example configurable interconnections 1710, and example storage circuitry 1712. The logic gate circuitry 1708 and the configurable interconnections 1710 are configurable to instantiate one or more operations that may correspond to at least some of the machine readable instructions of FIGS. 3-6 and/or other desired operations. The logic gate circuitry 1708 shown in FIG. 17 is fabricated in groups or blocks. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1708 to enable configuration of the electrical structures and/or the logic gates to form circuits to perform desired operations. The logic gate circuitry 1708 may include other electrical structures such as look-up tables (LUTs), registers (e.g., flip-flops or latches), multiplexers, etc.

The configurable interconnections 1710 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1708 to program desired logic circuits.

The storage circuitry 1712 of the illustrated example is structured to store result(s) of the one or more of the operations performed by corresponding logic gates. The storage circuitry 1712 may be implemented by registers or the like. In the illustrated example, the storage circuitry 1712 is distributed amongst the logic gate circuitry 1708 to facilitate access and increase execution speed.

The example FPGA circuitry 1700 of FIG. 17 also includes example Dedicated Operations Circuitry 1714. In this example, the Dedicated Operations Circuitry 1714 includes special purpose circuitry 1716 that may be invoked to implement commonly used functions to avoid the need to program those functions in the field. Examples of such special purpose circuitry 1716 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1700 may also include example general purpose programmable circuitry 1718 such as an example CPU 1720 and/or an example DSP 1722. Other general purpose programmable circuitry 1718 may additionally or alternatively be present such as a GPU, an XPU, etc., that can be programmed to perform other operations.

Although FIGS. 16 and 17 illustrate two example implementations of the processor circuitry 1512 of FIG. 15, many other approaches are contemplated. For example, as mentioned above, modern FPGA circuitry may include an on-board CPU, such as one or more of the example CPU 1720 of FIG. 17. Therefore, the processor circuitry 1512 of FIG. 15 may additionally be implemented by combining the example microprocessor 1600 of FIG. 16 and the example FPGA circuitry 1700 of FIG. 17. In some such hybrid examples, a first portion of the machine readable instructions represented by the flowcharts of FIGS. 3-6 may be executed by one or more of the cores 1602 of FIG. 16, a second portion of the machine readable instructions represented by the flowcharts of FIGS. 3-6 may be executed by the FPGA circuitry 1700 of FIG. 17, and/or a third portion of the machine readable instructions represented by the flowchart of FIGS. 3-6 may be executed by an ASIC. It should be understood that some or all of the circuitry of FIG. 15 may, thus, be instantiated at the same or different times. Some or all of the circuitry may be instantiated, for example, in one or more threads executing concurrently and/or in series. Moreover, in some examples, some or all of the circuitry of FIG. 15 may be implemented within one or more virtual machines and/or containers executing on the microprocessor.

In some examples, the processor circuitry 1512 of FIG. 15 may be in one or more packages. For example, the processor circuitry 1600 of FIG. 16 and/or the FPGA circuitry 1700 of FIG. 17 may be in one or more packages. In some examples, an XPU may be implemented by the processor circuitry 1512 of FIG. 15 which may be in one or more packages. For example, the XPU may include a CPU in one package, a DSP in another package, a GPU in yet another package, and an FPGA in still yet another package.

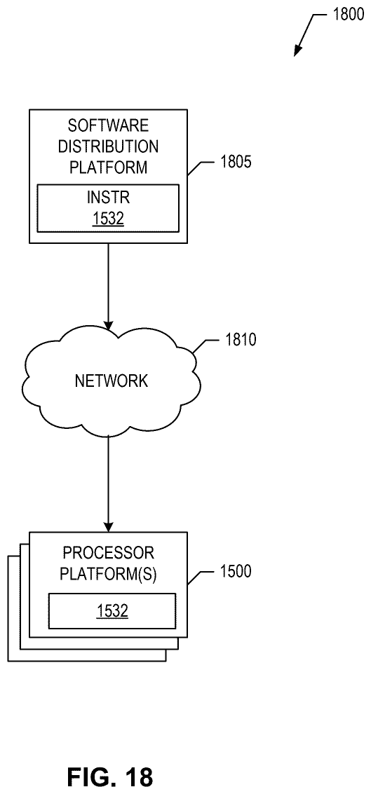

A block diagram illustrating an example software distribution platform 1505 to distribute software such as the example machine readable instructions 1532 of FIG. 15 to hardware devices owned and/or operated by third parties is illustrated in FIG. 18. The example software distribution platform 1805 may be implemented by any computer server, data facility, cloud service, etc., capable of storing and transmitting software to other computing devices. The third parties may be customers of the entity owning and/or operating the software distribution platform 1805. For example, the entity that owns and/or operates the software distribution platform 1805 may be a developer, a seller, and/or a licensor of software such as the example machine readable instructions 1532 of FIG. 15. The third parties may be consumers, users, retailers, OEMs, etc., who purchase and/or license the software for use and/or re-sale and/or sub-licensing. In the illustrated example, the software distribution platform 1805 includes one or more servers and one or more storage devices. The storage devices store the machine readable instructions 1532 of FIG. 15, which may correspond to the example machine readable instructions 300, 310, 335, 340 of FIGS. 3-6, as described above. The one or more servers of the example software distribution platform 1805 are in communication with a network 1810, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 1532 from the software distribution platform 1805. For example, the software, which may correspond to the example machine readable instructions 300, 310, 335, 340 of FIGS. 3-6 may be downloaded to the example processor platform 1500 which is to execute the machine readable instructions 1532 to implement the numerical computation approximator circuitry 110. In some example, one or more servers of the software distribution platform 1805 periodically offer, transmit, and/or force updates to the software (e.g., the example machine readable instructions 1532 of FIG. 15) to ensure improvements, patches, updates, etc., are distributed and applied to the software at the end user devices.

From the foregoing, it will be appreciated that example systems, methods, apparatus, and articles of manufacture have been disclosed that permit use of customizable bit-width lookup-based implementations in eltwiseop-intensive operators. In examples disclosed herein, the customizable bit-width lookup-table based implementation can be used to output values directly in a floating-point representation, such as FP16 (e.g., half-precision) or bfloat16. In examples disclosed herein, a novel softmax implementation specifically geared towards wide vectors that significantly reduces the number of exponential calls is introduced, thus significantly reducing the total compute time. In examples disclosed herein, an exponential-function specific implementation is introduced that (i) inputs data in tensor format, (ii) proposes a de-quantized range-reduction capability, and (iii) provides a tradeoff between tabulated LUT cost, compute cost and parallelization. Disclosed systems, methods, apparatus, and articles of manufacture are accordingly directed to one or more improvement(s) in the operation of a machine such as a computer or other electronic and/or mechanical device.

Example methods, apparatus, systems, and articles of manufacture for container attestation in client-based workloads are disclosed herein. Further examples and combinations thereof include the following:

Example 1 includes an apparatus, comprising at least one memory, machine readable instructions, and programmable circuitry to at least one of instantiate or execute the machine readable instructions to generate a lookup table based on input elements associated with a training phase of a deep neural network, index the lookup table using tensor values, the tensor values associated with an output index, and output a vector in destination numeric format based on the lookup table, the vector including output values in a floating-point representation.

Example 2 includes the apparatus of example 1, wherein the programmable circuitry is to generate the lookup table based on an expected input element.

Example 3 includes the apparatus of example 1, wherein the programmable circuitry is to regenerate the lookup table based on a current input element.

Example 4 includes the apparatus of example 1, wherein the programmable circuitry is to index a second lookup table based on a first output of the first lookup table.

Example 5 includes the apparatus of example 4, wherein the programmable circuitry is to combine the first output of the first lookup table and a second output of the second lookup table into an index of a third lookup table, the first output and the second output combined based on a numerical function.

Example 6 includes the apparatus of example 1, wherein the programmable circuitry is to generate a histogram of the input elements.

Example 7 includes the apparatus of example 6, wherein the programmable circuitry is to identify an index of a largest value in the histogram and scale the lookup table based on the largest value.

Example 8 includes the apparatus of example 7, wherein the programmable circuitry is to scale the lookup table to prevent an overflow.

Example 9 includes the apparatus of example 1, wherein the programmable circuitry is to identify unique input values, a unique input values total less than a total number of input values, and calculate resulting outputs associated with the unique input values, the resulting output associated with the input values.

Example 10 includes the apparatus of example 1, wherein the input elements include at least one of a compounded set of functions, an input type, quantization scheme parameters, or an output datatype.

Example 11 includes the apparatus of example 10, wherein the programmable circuitry is to generate the lookup table for the compounded set of functions when the output datatype is a destination numeric format.

Example 12 includes the apparatus of example 1, wherein the programmable circuitry is to identify when a size of an input vector is larger than a lookup address size.

Example 13 includes the apparatus of example 1, wherein the programmable circuitry is to initiate a piecewise-polynomial based on quantized input data.

Example 14 includes the apparatus of example 1, wherein the programmable circuitry is to perform exponential-specific range-reduction based on input tensor values.

Example 15 includes the apparatus of example 14, wherein the programmable circuitry is to output results of the exponential-specific range-reduction using a floating-point representation.

Example 16 includes a method, comprising generating, by executing an instruction with at least one processor, a lookup table based on input elements associated with a training phase of a deep neural network, indexing, by executing an instruction with at least one processor, the lookup table using tensor values, the tensor values associated with an output index, and outputting, by executing an instruction with at least one processor, a vector in destination numeric format based on the lookup table, the vector including output values in a floating-point representation.

Example 17 includes the method of example 16, further including generating the lookup table based on an expected input element.

Example 18 includes the method of example 16, further including generating the lookup table based on a current input element.

Example 19 includes the method of example 16, further including indexing a second lookup table based on a first output of the first lookup table.

Example 20 includes the method of example 19, further including combining the first output of the first lookup table and a second output of the second lookup table into an index of a third lookup table, the first output and the second output combined based on a numerical function.

Example 21 includes the method of example 16, further including generating a histogram of the input elements.

Example 22 includes the method of example 21, further including identifying an index of a largest value in the histogram and scaling the lookup table based on the largest value.

Example 23 includes the method of example 22, further including scaling the lookup table to prevent an overflow.

Example 24 includes the method of example 16, wherein the programmable circuitry is to identify unique input values, a unique input values total less than a total number of input values, and calculate resulting outputs associated with the unique input values, the resulting output associated with the input values.

Example 25 includes the method of example 16, wherein the input elements include a compounded set of functions, an input type, quantization scheme parameters, or an output datatype.

Example 26 includes the method of example 25, further including generating the lookup table for the compounded set of functions when the output datatype is a destination numeric format.

Example 27 includes the method of example 16, further including identifying when a size of an input vector is larger than a lookup address size.

Example 28 includes the method of example 16, further including initiating a piecewise-polynomial based on quantized input data.

Example 29 includes the method of example 16, further including performing exponential-specific range-reduction based on input tensor values.

Example 30 includes the method of example 29, further including outputting results of the exponential-specific range-reduction using a floating-point representation.

Example 31 includes a non-transitory machine readable storage medium comprising instructions that, when executed, cause processor circuitry to at least generate a lookup table based on input elements associated with a training phase of a deep neural network, index the lookup table using tensor values, the tensor values associated with an output index, and output a vector in destination numeric format based on the lookup table, the vector including output values in a floating-point representation.

Example 32 includes the non-transitory machine readable storage medium as defined in example 31, wherein the instructions, when executed, cause the processor to generate the lookup table based on an expected input element.

Example 33 includes the non-transitory machine readable storage medium as defined in example 31, wherein the instructions, when executed, cause the processor to regenerate the lookup table based on a current input element.

Example 34 includes the non-transitory machine readable storage medium as defined in example 31, wherein the instructions, when executed, cause the processor to index a second lookup table based on a first output of the first lookup table.

Example 35 includes the non-transitory machine readable storage medium as defined in example 34, wherein the instructions, when executed, cause the processor to combine the first output of the first lookup table and a second output of the second lookup table into an index of a third lookup table, the first output and the second output combined based on a numerical function.

Example 36 includes the non-transitory machine readable storage medium as defined in example 31, wherein the instructions, when executed, cause the processor to generate a histogram of the input elements.

Example 37 includes the non-transitory machine readable storage medium as defined in example 36, wherein the instructions, when executed, cause the processor to identify an index of a largest value in the histogram and scale the lookup table based on the largest value.

Example 38 includes the non-transitory machine readable storage medium as defined in example 37, wherein the instructions, when executed, cause the processor to scale the lookup table to prevent an overflow.

Example 39 includes the non-transitory machine readable storage medium as defined in example 31, wherein the instructions, when executed, cause the processor to identify unique input values, a unique input values total less than a total number of input values, and calculate resulting outputs associated with the unique input values, the resulting output associated with the input values.

Example 40 includes the non-transitory machine readable storage medium as defined in example 31, wherein the input elements include a compounded set of functions, an input type, quantization scheme parameters, or an output datatype.

Example 41 includes the non-transitory machine readable storage medium as defined in example 40, wherein the instructions, when executed, cause the processor to generate the lookup table for the compounded set of functions when the output datatype is a destination numeric format.

Example 42 includes the non-transitory machine readable storage medium as defined in example 31, wherein the instructions, when executed, cause the processor to identify when a size of an input vector is larger than a lookup address size.

Example 43 includes the non-transitory machine readable storage medium as defined in example 31, wherein the instructions, when executed, cause the processor to initiate a piecewise-polynomial based on quantized input data.

Example 44 includes the non-transitory machine readable storage medium as defined in example 31, wherein the instructions, when executed, cause the processor to perform exponential-specific range-reduction based on input tensor values.

Example 45 includes the non-transitory machine readable storage medium as defined in example 44, wherein the instructions, when executed, cause the processor to output results of the exponential-specific range-reduction using a floating-point representation.

Example 46 includes an apparatus, comprising means for generating a lookup table based on input elements associated with a training phase of a deep neural network, means for indexing the lookup table using tensor values, and means for outputting a vector in destination numeric format based on the lookup table, the vector including output values in a floating-point representation.

Example 47 includes the apparatus of example 46, wherein the means for generating a lookup table is to generate the lookup table based on an expected input element.

Example 48 includes the apparatus of example 46, wherein the means for generating the lookup table is to regenerate the lookup table based on a current input element.

Example 49 includes the apparatus of example 46, wherein the means for indexing the lookup table is to index a second lookup table based on a first output of the first lookup table.

Example 50 includes the apparatus of example 49, wherein the means for indexing the lookup table is to combine the first output of the first lookup table and a second output of the second lookup table into an index of a third lookup table, the first output and the second output combined based on a numerical function.

Example 51 includes the apparatus of example 46, further including means for generating a histogram of the input elements.

Example 52 includes the apparatus of example 51, wherein the means for indexing the lookup table is to identify an index of a largest value in the histogram and scale the lookup table based on the largest value.

Example 53 includes the apparatus of example 51, wherein the means for indexing the lookup table is to scale the lookup table to prevent an overflow.

Example 54 includes the apparatus of example 46, wherein the means for generating a lookup table is to identify unique input values, a unique input values total less than a total number of input values, and calculate resulting outputs associated with the unique input values, the resulting output associated with the input values.

Example 55 includes the apparatus of example 46, wherein the input elements include a compounded set of functions, an input type, quantization scheme parameters, or an output datatype.

Example 56 includes the apparatus of example 55, wherein the means for generating a lookup table include generating the lookup table for the compounded set of functions when the output datatype is a destination numeric format.

Example 57 includes the apparatus of example 46, wherein the means for generating a lookup table include identifying when a size of an input vector is larger than a lookup address size.

Example 58 includes the apparatus of example 46, wherein the means for generating the lookup table is to initiate a piecewise-polynomial based on quantized input data.

Example 59 includes the apparatus of example 46, wherein the means for generating the lookup table is to perform exponential-specific range-reduction based on input tensor values.

Example 60 includes the apparatus of example 59, wherein the means for outputting the vector is to output results of the exponential-specific range-reduction using a floating-point representation.

The following claims are hereby incorporated into this Detailed Description by this reference. Although certain example systems, methods, apparatus, and articles of manufacture have been disclosed herein, the scope of coverage of this patent is not limited thereto. On the contrary, this patent covers all systems, methods, apparatus, and articles of manufacture fairly falling within the scope of the claims of this patent.

1. An apparatus, comprising:
at least one memory;
machine readable instructions; and
programmable circuitry to at least one of instantiate or execute the machine readable instructions to:
generate a lookup table based on input elements associated with a training phase of a deep neural network;
index the lookup table using tensor values, the tensor values associated with an output index; and
output a vector in destination numeric format based on the lookup table, the vector including output values in a floating-point representation.

2. The apparatus as defined in claim 1, wherein the programmable circuitry is to generate the lookup table based on an expected input element.

3. The apparatus as defined in claim 1, wherein the programmable circuitry is to regenerate the lookup table based on a current input element.

4. The apparatus as defined in claim 1, wherein the programmable circuitry is to index a second lookup table based on a first output of the first lookup table.

5. The apparatus as defined in claim 4, wherein the programmable circuitry is to combine the first output of the first lookup table and a second output of the second lookup table into an index of a third lookup table, the first output and the second output combined based on a numerical function.

6. The apparatus as defined in claim 1, wherein the programmable circuitry is to generate a histogram of the input elements.

7. The apparatus as defined in claim 6, wherein the programmable circuitry is to identify an index of a largest value in the histogram and scale the lookup table based on the largest value.

8. The apparatus as defined in claim 7, wherein the programmable circuitry is to scale the lookup table to prevent an overflow.

9. A method, comprising:
generating, by executing an instruction with at least one processor, a lookup table based on input elements associated with a training phase of a deep neural network;
indexing, by executing an instruction with at least one processor, the lookup table using tensor values, the tensor values associated with an output index; and
outputting, by executing an instruction with at least one processor, a vector in destination numeric format based on the lookup table, the vector including output values in a floating-point representation.

10. The method as defined in claim 9, further including generating the lookup table based on an expected input element.

11. The method as defined in claim 9, further including generating the lookup table based on a current input element.

12. The method as defined in claim 9, further including indexing a second lookup table based on a first output of the first lookup table.

13. The method as defined in claim 12, further including combining the first output of the first lookup table and a second output of the second lookup table into an index of a third lookup table, the first output and the second output combined based on a numerical function.

14. The method as defined in claim 9, further including generating a histogram of the input elements.

15. The method as defined in claim 14, further including identifying an index of a largest value in the histogram and scaling the lookup table based on the largest value.

16. The method as defined in claim 15, further including scaling the lookup table to prevent an overflow.

17. A non-transitory machine readable storage medium comprising instructions that, when executed, cause processor circuitry to at least:
generate a lookup table based on input elements associated with a training phase of a deep neural network;
index the lookup table using tensor values, the tensor values associated with an output index; and
output a vector in destination numeric format based on the lookup table, the vector including output values in a floating-point representation.

18. The non-transitory machine readable storage medium as defined in claim 17, wherein the instructions, when executed, cause the processor to generate the lookup table based on an expected input element.

19. The non-transitory machine readable storage medium as defined in claim 17, wherein the instructions, when executed, cause the processor to regenerate the lookup table based on a current input element.

20. The non-transitory machine readable storage medium as defined in claim 17, wherein the instructions, when executed, cause the processor to index a second lookup table based on a first output of the first lookup table.

21.-25. (canceled)
